(19) United States
(12) Patent Application Publication
(10) Pub. No.: US 2025/0113382 A1
(43) Pub. Date: Apr. 3, 2025

(54) APPARATUS AND METHOD FOR PERFORMING UPLINK TRANSMISSIONS FOR RANDOM ACCESS

(71) Applicant: SHARP KABUSHIKI KAISHA, Sakai City, Osaka (JP)

(72) Inventors: CHIA-HUNG WEI, Taipei (TW); HAI-HAN WANG, Taipei (TW); CHIE-MING CHOU, Taipei (TW)

(21) Appl. No.: 18/832,698

(22) PCT Filed: Jan. 17, 2023
(86) PCT No.: PCT/CN2023/072648

§ 371 Date: Jul. 24, 2024

Related U.S. Application Data
(60) Provisional application No. 63/304,510, filed on Jan. 28, 2022.

(51) Int. Cl. H04W 74/0833; H04B 17/318; H04L 5/00; H04W 74/00

(52) U.S. Cl. CPC H04W 74/0833; H04B 17/328; H04L 5/0048; H04W 74/006

(57) ABSTRACT

A method for a User Equipment (UE) for performing uplink transmissions for Random Access (RA) is provided. The method receives, from a base station, at least one configuration indicating a first threshold and initiates an RA procedure. The method determines whether to perform Multiple Physical Random Access Channel (PRACH) (MP) transmissions based on, at least, a comparison between a measurement result and the first threshold. The method then selects a PRACH resource configured for the MP transmissions in response to determining that the MP transmissions are to be performed. Performing the MP transmissions includes transmitting, repeatedly, an RA preamble, on the PRACH resource configured for the MP transmissions, before the UE begins monitoring a Physical Downlink Control Channel (PDCCH) for receiving a Random Access Response (RAR) that corresponds to the RA preamble.

### CROSS-REFERENCE TO RELATED APPLICATION(S)

The present disclosure is the National Stage Application of International Patent Application Serial No. PCT/CN2023/072648, filed on Jan. 17, 2023, which claims the benefit of and priority to U.S. Provisional Patent Application Ser. No. 63/304,510, filed on Jan. 28, 2022, the contents of all of which are hereby incorporated herein fully by reference into the present application for all purposes.

### FIELD

The present disclosure generally relates to wireless communication and, more particularly, to apparatuses and methods for performing uplink transmissions for Random Access (RA).

### BACKGROUND

Some of the abbreviations in the present application are defined as follows and, unless otherwise specified, the abbreviations have the following meanings:

### Abbreviation Full Name

3GPP 3rd Generation Partnership Project
5G 5th Generation
5GC 5G Core
AM Acknowledge Mode
AS Access Stratum
BA Bandwidth Aggregation
BFR Beam Failure Recovery
BS Base Station
BSR Buffer Status Reporting
BWP Band Width Part
CA Carrier Aggregation
CBRA Contention-Based Random Access
CC Component Carriers
CCCH Common Control Channel
CE Control Element
CFRA Contention-Free Random Access
CG Cell Group
CORESET Control Resource Set
C-RNTI Cell Radio Network Temporary Identifier
CS-RNTI Configured Scheduling Radio Network Temporary Identifier
CSI Channel State Information
CSI-RS Channel State Information Reference Signal
CQI Channel Quality Indicator
DC Dual Connectivity
DCI Downlink Control Information
DL Downlink
DL-SCH Downlink Shared Channel
DTCH Dedicated Traffic Channel
DRB Data Radio Bearer
eMBB Enhanced Mobile Broadband
EN-DC E-UTRA NR Dual Connect
gNB Next-Generation Node B
HO Handover
IE Information Element
L1 Layer 1
L2 Layer 2
LCH Logical Channel
LCID Logical Channel Identity
LTE Long Term Evolution
MAC Medium Access Control
MCG Master Cell Group
MCS-C-RNTI Modulation Coding Scheme Cell Radio Network Temporary Identifier
MIMO Multi-Input Multi-Output
mMTC massive Machine Type Communications
MSG0 Message-0
MSG1 Message-1
MSG2 Message-2
MSG3 Message-3
MSG4 Message-4
MSGA Message-A
MSGB Message-B
MP Multiple Physical Random Access Channel
NAS Non-Access Stratum
NDI New Data Indicator
NG-C Next-Generation Core
NR New Radio
NUL Normal Uplink
PCell Primary Cell
PDCCH Physical Downlink Control Channel
PDCP Packet Data Convergence Protocol
PDU Protocol Data Unit
PHY Physical
PRACH Physical Random Access Channel
PSCell Primary SCell
PUCCH Physical Uplink Control Channel
PUSCH Physical Uplink Shared Channel
QOS Quality of Service
RA Random Access
RAT Radio Access Technology
RACH Random Access Channel
RAR Random Access Response
Rel-15 Release 15
Rel-16 Release 16
RLC Radio Link Control
RLF Radio Link Failure
RNTI Radio Network Temporary Identifier
RRC Radio Resource Control
RRM Radio Resource Management
RS Reference Signal
RSRP Reference Signal Received Power
RTT Round Trip Time
Rx Receiving
SCell Secondary Cell
SCG Secondary Cell Group
SDU Service Data Unit
SI System Information
SIB System Information Block
SINR Signal to Interference and Noise Ratio
SLIV Start and Length Indicator Value
SR Scheduling Request
SRB Signaling Radio Bearer
SRS Sounding Reference Signal
SSB Synchronization Signal Block
SP Single Physical Random Access Channel
SpCell Special Cell
SUL Supplementary Uplink
TA Timing Advance
TAG Timing Advance Group
TB Transport Block
TNL Transport Network Layer
TR Technical Report
TRP Transmission/Reception Point
TS Technical Specification
Tx Transmitting
UE User Equipment
UL Uplink
UL-SCH Uplink Shared Channel
URLLC Ultra-Reliable and Low-Latency Communications

With the tremendous growth in the number of connected devices and the rapid increase in user/network traffic volume, various efforts have been made to improve different aspects of wireless communication for the next-generation wireless communication systems, such as the fifth-generation (5G) New Radio (NR) system, by improving data rate, latency, reliability, and mobility.

The 5G NR system is designed to provide flexibility and configurability to optimize network services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation wireless communication systems.

### SUMMARY

The present disclosure is directed to apparatuses and methods for performing uplink transmissions for Random Access (RA).

According to a first aspect of the present disclosure, a method for performing uplink transmissions by a User Equipment (UE) is provided. The method includes receiving, from a Base Station (BS), at least one configuration indicating a first threshold; initiating a Random Access (RA) procedure; determining whether to perform Multiple Physical Random Access Channel (PRACH) (MP) transmissions based on, at least, a comparison between a measurement result and the first threshold; and selecting a PRACH resource configured for the MP transmissions in response to determining that the MP transmissions are to be performed. Performing the MP transmissions includes transmitting, repeatedly, an RA preamble, on the PRACH resource configured for the MP transmissions, before the UE begins monitoring a Physical Downlink Control Channel (PDCCH) for receiving a Random Access Response (RAR) that corresponds to the RA preamble.

In some implementations of the first aspect of the present disclosure, the measurement result includes at least one Reference Signal Received Power (RSRP) value of at least one pathloss Reference Signal (RS). The method further includes performing a set of operations after determining that all of the at least one RSRP value is less than the first threshold. Performing the set of operations includes determining whether the at least one pathloss RS is associated with at least one MP-specific PRACH resource that is configured for the UE to perform the MP transmissions, the at least one MP-specific PRACH resource including the PRACH resource configured for the MP transmissions; and performing the MP transmissions after determining that the at least one pathloss RS is associated with the at least one MP-specific PRACH resource.

In some implementations of the first aspect of the present disclosure, performing the set of operations further includes performing a Single PRACH (SP) transmission after determining that none of the at least one pathloss RS is associated with the at least one MP-specific PRACH resource. Performing the SP transmission includes transmitting the RA preamble for the RA procedure only once before the UE begins monitoring the PDCCH for receiving the RAR that corresponds to the RA preamble.

In some implementations of the first aspect of the present disclosure, selecting the PRACH resource configured for the MP transmissions includes selecting an MP-specific PRACH resource, among the at least one MP-specific PRACH resource, as the PRACH resource for transmitting the RA preamble.

In some implementations of the first aspect of the present disclosure, the method further includes performing the MP transmissions after determining that the measurement result is less than the first threshold; and performing a Single-PRACH (SP) transmission after determining that the measurement result is equal to, or greater than, the first threshold. Performing the SP transmission includes transmitting the RA preamble for the RA procedure only once before the UE begins monitoring the PDCCH for receiving the RAR that corresponds to the RA preamble.

In some implementations of the first aspect of the present disclosure, selecting the PRACH resource configured for the MP transmissions includes selecting the PRACH resource by comparing the measurement result with the first threshold.

In some implementations of the first aspect of the present disclosure, selecting the PRACH resource configured for the MP transmissions includes selecting the PRACH resource by comparing the measurement result with a second threshold, where the first threshold and the second threshold are independently indicated by the at least one configuration.

In some implementations of the first aspect of the present disclosure, the method further includes receiving, from the BS, an indication of whether a second threshold is used as the first threshold, where the second threshold is configured for the UE to select the PRACH resource for transmitting the RA preamble.

In some implementations of the first aspect of the present disclosure, the method further includes determining whether to indicate to the BS that the UE is capable of performing Message 3 (MSG3) repetitions according to the first threshold. Performing the MSG3 repetitions include transmitting, repeatedly, an MSG3 for the RA procedure after receiving the RAR.

According to a second aspect of the present disclosure, a User Equipment (UE) for performing uplink transmissions is provided. The UE includes at least one processor and at least one non-transitory computer-readable medium coupled to the at least one processor and storing one or more computer-executable instructions that, when executed by the at least one processor, cause the UE to receive, from a Base Station (BS), at least one configuration indicating a first threshold; initiate a Random Access (RA) procedure; determine whether to perform Multiple Physical Random Access Channel (PRACH) (MP) transmissions based on, at least, a comparison between a measurement result and the first threshold; and select a PRACH resource configured for the MP transmissions in response to determining that the MP transmissions are to be performed. Performing the MP transmissions includes transmitting, repeatedly, an RA preamble, on the PRACH resource configured for the MP transmissions, before the UE begins monitoring a Physical Downlink Control Channel (PDCCH) for receiving a Random Access Response (RAR) that corresponds to the RA preamble.

In some implementations of the second aspect of the present disclosure, the measurement result includes at least one Reference Signal Received Power (RSRP) value of at least one pathloss Reference Signal (RS). The one or more computer-executable instructions, when executed by the at least one processor, further cause the UE to perform a set of operations after the UE determines that all of the at least one RSRP value is less than the first threshold. Performing the set of operations includes determining whether the at least one pathloss RS is associated with at least one MP-specific PRACH resource that is configured for the UE to perform the MP transmissions, the at least one MP-specific PRACH resource including the PRACH resource configured for the MP transmissions; and performing the MP transmissions after the UE determines that the at least one pathloss RS is associated with the at least one MP-specific PRACH resource.

In some implementations of the second aspect of the present disclosure, performing the set of operations further includes performing a Single-PRACH (SP) transmission after the UE determines that none of the at least one pathloss RS is associated with the at least one MP-specific PRACH resource. Performing the SP transmission includes transmitting the RA preamble for the RA procedure only once before the UE begins monitoring the PDCCH for receiving the RAR that corresponds to the RA preamble.

In some implementations of the second aspect of the present disclosure, selecting the PRACH resource configured for the MP transmissions includes selecting an MP-specific PRACH resource, among the at least one MP-specific PRACH resource, as the PRACH resource for transmitting the RA preamble.

In some implementations of the second aspect of the present disclosure, the one or more computer-executable instructions, when executed by the at least one processor, further cause the UE to perform the MP transmissions after the UE determines that the measurement result is less than the first threshold; and perform a Single-PRACH (SP) transmission after the UE determines that the measurement result is equal to, or greater than, the first threshold. Performing the SP transmission includes transmitting the RA preamble for the RA procedure only once before the UE begins monitoring the PDCCH for receiving the RAR that corresponds to the RA preamble.

In some implementations of the second aspect of the present disclosure, selecting the PRACH resource configured for the MP transmissions includes selecting the PRACH resource by comparing the measurement result with the first threshold.

In some implementations of the second aspect of the present disclosure, selecting the PRACH resource configured for the MP transmissions includes selecting the PRACH resource by comparing the measurement result with a second threshold, where the first threshold and the second threshold are independently indicated by the at least one configuration.

In some implementations of the second aspect of the present disclosure, the one or more computer-executable instructions, when executed by the at least one processor, further cause the UE to receive, from the BS, an indication of whether a second threshold is used as the first threshold, where the second threshold is configured for the UE to select the PRACH resource for transmitting the RA preamble.

In some implementations of the second aspect of the present disclosure, the one or more computer-executable instructions, when executed by the at least one processor, further cause the UE to determine whether to indicate to the BS that the UE is capable of performing multiple Message 3 (MSG3) repetitions according to the first threshold. Performing the MSG3 repetitions includes transmitting, repeatedly, an MSG3 for the RA procedure after the UE receives the RAR.

According to a third aspect of the present disclosure, a Base Station (BS) for communicating with a User Equipment (UE) performing uplink transmissions is provided. The BS includes at least one processor and at least one non-transitory computer-readable medium coupled to the at least one processor and storing one or more computer-executable instructions that, when executed by the at least one processor, cause the BS to transmit at least one configuration indicating a first threshold to the UE; transmit at least one pathloss Reference Signal (RS) to the UE, causing the UE to determine whether to perform Multiple Physical Random Access Channel (PRACH) (MP) transmissions based on, at least, a comparison between a measurement result and the first threshold, and further causing the UE to select a PRACH resource configured for the MP transmissions in response to determining that the MP transmissions are to be performed; and receive, repeatedly, a Random Access (RA) preamble for an RA procedure in response to the UE performing the MP transmissions.

In some implementations of the third aspect of the present disclosure, the one or more computer-executable instructions, when executed by the at least one processor, further cause the BS to transmit an indication of whether a second threshold is used as the first threshold to the UE, where the second threshold is configured for the UE to select the PRACH resource for transmitting the RA preamble.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a sequence diagram illustrating a CBRA procedure, according to an implementation of the present disclosure.

FIG. 2 is a sequence diagram illustrating a CFRA procedure, according to an implementation of the present disclosure.

FIG. 3 is a sequence diagram illustrating an RA procedure with MP transmissions, according to an implementation of the present disclosure.

FIG. 4 is a flowchart illustrating a method/procedure for determining whether an initiated RA procedure uses an SP transmission or MP transmissions, according to an implementation of the present disclosure.

FIG. 5 is a diagram illustrating a comparison between measurement results and individual RSRP thresholds, according to an implementation of the present disclosure.

FIG. 6 is a diagram illustrating that all of the detected DL RSs have RSRP values less than a specific RSRP threshold, according to an implementation of the present disclosure.

FIG. 7 is a diagram illustrating that all of the detected DL RSs have RSRP values less than a specific RSRP threshold, according to an implementation of the present disclosure.

FIG. 8 is a flowchart illustrating a method/process performed by a UE to determine whether to perform MP transmissions or to perform an SP transmission, according to an implementation of the present disclosure.

FIG. 9 is a diagram illustrating that the decision to perform MP transmissions and the selection of the PRACH resource for the MP transmissions are based on the RSRP_EUT and RSRP_EUTSSB, according to an implementation of the present disclosure.

FIG. 10 is a flowchart illustrating a method/process for performing uplink transmissions, according to an example implementation of the present disclosure.

FIG. 11 is a flowchart illustrating a method/process for communicating with a UE that is performing uplink transmissions, according to an example implementation of the present disclosure.

FIG. 12 is a block diagram illustrating a node for wireless communication, according to an example implementation of the present disclosure.

### DETAILED DESCRIPTION

The following contains specific information related to implementations of the present disclosure. The drawings and their accompanying detailed description are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may differ in other respects and shall not be narrowly confined to what is illustrated in the drawings.

The phrases “in some implementations” or “in some implementations” may each refer to one or more of the same or different implementations. The term “coupled” is defined as connected, whether directly or indirectly via intervening components, and is not necessarily limited to physical connections. The term “comprising” means “including, but not necessarily limited to,” and specifically indicates open-ended inclusion or membership in the disclosed combination, group, series, or equivalent. The expression “at least one of A, B, and C” or “at least one of the following: A, B, and C” means “only A, or only B, or only C, or any combination of A, B and C.”

The terms “system” and “network” may be used interchangeably. The term “and/or” is only an association relationship for disclosing associated objects and represents that three relationships may exist such that A and/or B may indicate that A exists alone, A and B exist at the same time, or B exists alone. “A and/or B and/or C” may represent that at least one of A, B, and C exists. The character “/” generally represents that the associated objects are in an “or” relationship.

For the purposes of explanation and non-limitation, specific details, such as functional entities, techniques, protocols, standards, and the like, are set forth for providing an understanding of the disclosed technology. In other examples, detailed disclosures of well-known methods, technologies, systems, architectures, and the like are omitted so as not to obscure the present disclosure with unnecessary details.

Persons skilled in the art will immediately recognize that any disclosed network function(s) or algorithm(s) may be implemented by hardware, software, or a combination of software and hardware. Disclosed functions may correspond to modules which may be software, hardware, firmware, or any combination thereof.

A software implementation may include computer-executable instructions stored on a computer-readable medium, such as memory or other type of storage devices. One or more microprocessors or general-purpose computers with communication processing capability may be programmed with corresponding computer-executable instructions and perform the disclosed network function(s) or algorithm(s).

The microprocessors or general-purpose computers may include Application-Specific Integrated Circuits (ASICs), programmable logic arrays, and/or one or more Digital Signal Processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) may typically include at least one base station (BS), at least one UE, and one or more optional network elements that provide connection within a network. The UE may communicate with the network, such as a Core Network (CN), an Evolved Packet Core (EPC) network, an Evolved Universal Terrestrial RAN (E-UTRAN), a Next-Generation Core (NGC), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE may be configured to receive and transmit signals over an air interface to one or more cells in a RAN.

The BS may be configured to provide communication services according to at least a Radio Access Technology (RAT), such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, a next-generation eNB (ng-eNB) in an Evolved Universal Terrestrial Radio Access (E-UTRA) BS in connection with 5GC, a next-generation Node B (gNB) in the 5G-RAN (or in the 5G Access Network (5G-AN)), or any other apparatus capable of controlling radio communication and managing radio resources within a cell. The BS may serve one or more UEs via a radio interface.

The BS may provide radio coverage to a specific geographical area using several different cells included in the RAN. The BS may support the operations of the cells. Each cell may be operable to provide services to at least one UE within its radio coverage.

Each cell (often referred to as a serving cell) may provide services to serve one or more UEs within its radio coverage, such that each cell may schedule the downlink (DL) and optionally uplink (UL) resources to at least one UE within its radio coverage for DL and optionally UL packet transmissions. The BS may communicate with one or more UEs in the radio communication system via the different cells.

A cell may allocate Sidelink (SL) resources for supporting the Proximity Service (ProSe), LTE SL services, LTE/NR sidelink communication services, LTE/NR sidelink discovery services, and/or LTE/NR Vehicle-to-Everything (V2X) services.

The terms, definitions, and abbreviations, as given in this document, may include the existing definitions in the art (e.g., European Telecommunications Standards Institute (ETSI), International Telecommunication Union (ITU), or elsewhere) or may have been newly created by the 3GPP experts whenever the need for precise vocabulary was identified.

Examples of some selected terms are provided as follows.

Cell: A radio network object that may be uniquely identified by a User Equipment from a (cell) identification that is broadcast over a geographical area from, for example, a UTRAN Access Point. A Cell is either in an FDD mode or a TDD mode.

Serving Cell: For a UE in the RRC_CONNECTED state, that is not configured with CA/DC, there is only one serving cell including a primary cell. For a UE in the RRC_CONNECTED state, that is configured with CA/DC, the term ‘serving cells’ is used to denote a set of cells including the Special Cell(s) and all secondary cells.

CA: In Carrier Aggregation (CA), two or more Component Carriers (CCs) are aggregated. A UE may simultaneously receive or transmit on one or multiple CCs depending on its capabilities. CA is supported for both contiguous and non-contiguous CCs. When CA is deployed, the frame timing and SFN may be aligned across cells that are capable of aggregation. The maximum number of configured CCs for a UE is 16 for DL and 16 for UL. When CA is configured, the UE may only have one RRC connection with the network. At the RRC connection establishment/re-establishment/handover, a serving cell may provide the NAS mobility information, and at the RRC connection re-establishment/handover, a serving cell may provide the security input. Such a cell may be referred to as the Primary Cell (PCell). Depending on the UE capabilities, Secondary Cells (SCells) may be configured to form, together with the PCell, a set of serving cells. Therefore, the configured set of serving cells for a UE may always include one PCell and one or more SCells.

BWP: A subset of the total cell bandwidth of a cell is referred to as a Bandwidth Part (BWP) and a Bandwidth Adaptation (BA) may be achieved by configuring the UE with BWP(s) and instructing the UE which of the configured BWPs is currently the active one. To enable a BA on the PCell, the gNB configures the UE with UL and DL BWP(s). To enable the BA on SCells, in case of CA, the gNB configures the UE with at least one or more DL BWPs (e.g., there may be no BWP in the UL). For the PCell, the initial BWP is the BWP used for an initial access. For the SCell(s), the initial BWP is the BWP configured for the UE to operate after an SCell activation. The UE may be configured with a first active uplink BWP by a firstActive UplinkBWP IE. If the first active uplink BWP is configured for an SpCell, the firstActive UplinkBWP IE field may contain the ID of the UL BWP to be activated upon performing the RRC (re-)configuration. If the field is absent, the RRC (re-)configuration does not impose a BWP switching. If the first active uplink BWP is configured for an SCell, the firstActive UplinkBWP IE field contains the ID of the uplink bandwidth part to be used upon the MAC-activation of an SCell.

Timer: A MAC entity may set up one or more timers for different purposes, for example, triggering one or more uplink signaling retransmissions or limiting one or more uplink signaling retransmission periods. A timer is running once it is started, until it is stopped, or until it expires; otherwise, it is not running. A timer may be started if it is not running, or restarted if it is running. A timer is always started or restarted from its initial value. The initial value may be, but is not limited to be, configured by the gNB via downlink RRC signaling or be a pre-defined/pre-determined value addressed in some specifications.

PDCCH: In the downlink, the gNB may dynamically allocate resources to the UEs at least via the C-RNTI/MCS-C-RNTI/CS-RNTI on PDCCH(s). A UE always monitors the PDCCH(s) in order to find possible assignments when its downlink reception is enabled (e.g., activities governed by the DRX when configured). When CA is configured, the same C-RNTI applies to all serving cells. In NR wireless communication systems, a downlink data reception at the UE side is achieved by monitoring the PDCCH and finding a possible assignment. The assignment may be represented as (UE-specific) DCI. The DCI may be identified on the PDCCH via blind decoding. From the implementation of the blind decoding aspect, the UE may be configured with a set of PDCCH candidates within one or more CORESETs. The PDCCH candidate set for the UE to monitor may be defined in terms of PDCCH search space sets (or search space sets).

A search space set may be categorized into two types (e.g., a Common Search space (CSS) set or a UE-Specific Search Space (USS) set). That is, a UE monitors the PDCCH candidates, according to one or more configured search space sets to decode a possible PDCCH transmitted by the gNB. In other words, a PDCCH may be identified in the PDCCH candidates within the monitored search space sets. More specifically, in some implementations, the UE may monitor a set of PDCCH candidates in one or more CORESETs and/or Search Spaces on a DL BWP (e.g., the active DL BWP on each activated serving cell or the initial BWP on a camped cell) configured with the PDCCH monitoring, according to corresponding search space sets, where the monitoring implies decoding each PDCCH candidate, according to the monitored DCI formats. That is, the DCI with CRC bits scrambled by a UE-specific RNTI (e.g., C-RNTI) may be carried by the PDCCH, and the DCI may be identified by the UE descrambling the CRC bits with the RNTI.

PDSCH/PUSCH: The PDCCH may be used to schedule the DL transmissions on a PDSCH, and UL transmissions on a PUSCH.

Transport Block: The data received from the upper layer (or MAC), for example, given to the physical layer, may be referred to as a transport block.

HARQ: A functionality that ensures the delivery between peer entities at Layer 1 (e.g., Physical Layer). A single HARQ process supports one Transport Block (TB) when the physical layer is not configured for the downlink/uplink spatial multiplexing, and when the physical layer is configured for downlink/uplink spatial multiplexing, a single HARQ process may support one or more TBs. There is one HARQ entity per serving cell. Each HARQ entity may support a parallel (number of) DL and UL HARQ process.

Hybrid automatic repeat request acknowledgement (HARQ-ACK): A HARQ-ACK information bit value of 0 represents a negative acknowledgement (NACK) while a HARQ-ACK information bit value of 1 represents a positive acknowledgement (ACK).

Beam: A beam may refer to a spatial (domain) filtering. In one example, the spatial filtering is applied in the analog domain by adjusting a phase and/or amplitude of the signal before being transmitted by a corresponding antenna element. In another example, the spatial filtering is applied in the digital domain by the Multi-Input Multi-Output (MIMO) technique in the wireless communication system. For example, “a UE made a PUSCH transmission by using a specific beam” means that the UE made the PUSCH transmission by using the specific spatial/digital domain filter. The “beam” may also be, but is not limited to be, represented as an antenna, an antenna port, an antenna element, a group of antennas, a group of antenna ports, or a group of antenna elements. The beam may also be formed by a certain reference signal resource. In short, the beam may be equivalent to a spatial domain filter through which the EM wave is radiated.

A DL RRC message in the present disclosure may include, but is not limited to, an RRC reconfiguration message (RRCReconfiguration), an RRC resume message (RRCResume), an RRC reestablishment message (RRCReestablishment), an RRC setup message (RRCSetup) or any other DL unicast RRC message.

A PDSCH/PDSCH/PUSCH transmission may span multiple symbols in the time domain. A time duration of a PDSCH/PDSCH/PUSCH (transmission) implies a time interval that starts from the beginning of the first symbol of the PDSCH/PDSCH/PUSCH (transmission) and ends at the end of the last symbol of the PDSCH/PDSCH/PUSCH (transmission).

The term “(specific) PHY layer signaling” may refer to a specific format of the DCI, a specific field of the DCI, a specific field of the DCI with the field being set to a specific value, and/or the DCI with Cyclic Redundancy Check (CRC) bits scrambled with a specific RNTI.

NR wireless communication systems were developed by the 3GPP in Release 15, as one of the world's representative 5G mobile networks. NR significantly improves the performance, flexibility, scalability, and efficiency of legacy mobile networks, such as the 3GPP LTE networks. By using a series of novel mechanisms introduced for NR, a BS (e.g., a gNB in NR) may provide a variety of services across different spectrum ranges, such as the eMBB, URLLC, and the mMTC. As defined in the 3GPP technical specification, NR may be used in two frequency ranges: Frequency Range 1 (FR1) for bands within 410 MHz to 7125 MHZ, and Frequency Range 2 (FR2) for bands within 24250 MHz to 52600 MHZ.

In NR, RA (or an RA procedure) refers to a procedure that a UE may use to inform a gNB of the UE's presence and then to establish an RRC configuration/connection for the UE to move/transition from an RRC_IDLE/RRC_INACTIVE state to an RRC_CONNECTED state. In addition to establishing the RRC connection with the gNB, a UE may initiate an RA procedure for other purposes, such as requesting uplink resources, requesting system information, or for beam failure recovery.

There are at least two types of RA procedures: a CBRA procedure and a CFRA procedure.

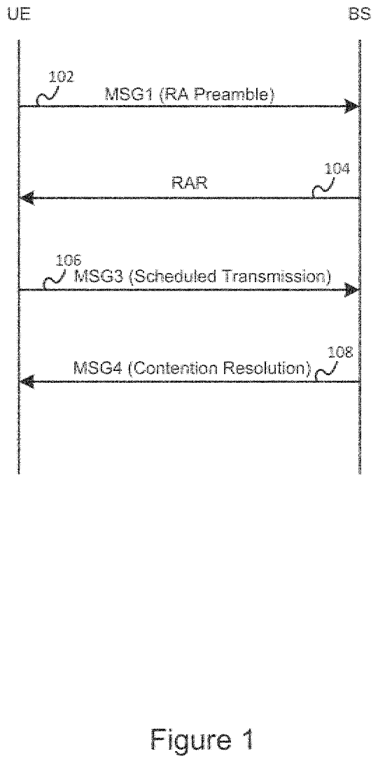

FIG. 1 is a sequence diagram illustrating a CBRA procedure, according to an implementation of the present disclosure. As illustrated in FIG. 1, the CBRA procedure includes actions 102, 104, 106 and 108. In action 102 (or an RA preamble transmission step/stage), a UE may transmit an MSG1 to a BS (e.g., gNB). For example, the MSG1 transmission may include an RA preamble transmission on a PRACH. The UE may then monitor a DL channel (e.g., the PDCCH) for receiving a response (e.g., a RAR), that corresponds to the MSG1, from the BS within a configured time window. In action 104, the BS may transmit a RAR to the UE in response to receiving the MSG1 from the UE. In action 106, after receiving the RAR, the UE may transmit an MSG3 to the BS in a scheduled transmission (e.g., scheduled by the RAR) by using a UL grant provided by the RAR. Then, the UE may monitor a DL channel for receiving the contention resolution from the BS. In action 108, the UE may receive an MSG4 (e.g., the contention resolution) from the BS. If the contention resolution is successful, the CBRA procedure ends. If the contention resolution is not successful after one or more MSG3 (re) transmissions, the CBRA procedure may return to action 102 in which the UE may perform the MSG1 transmission again.

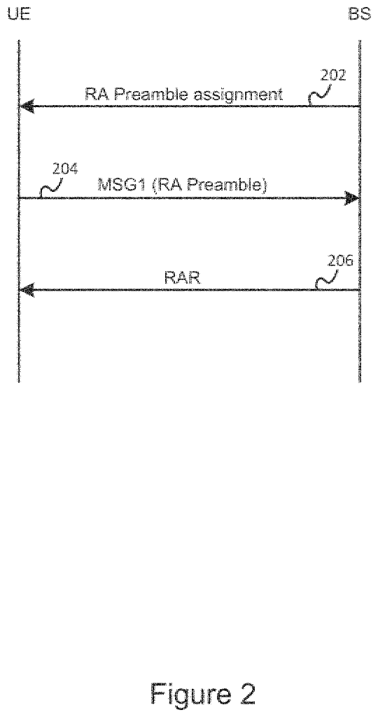

FIG. 2 is a sequence diagram illustrating a CFRA procedure, according to an implementation of the present disclosure. As illustrated in FIG. 2, a UE may receive an RA preamble assignment from a BS in action 202. The RA preamble assignment may indicate a resource allocation of an RA preamble transmission. In action 204, the UE 220 may transmit an MSG1 (e.g., including an RA preamble), according to the indicated resource allocation. In action 206, if the UE receives a RAR, as a response to the MSG1, from the BS. The CFRA procedure may then end.

The network operators may be interested in increasing the coverage of their serving cells when commercializing a cellular communication network. The subscribers may also expect ubiquitous coverage to support their desired QoS. Compared to the LTE systems, NR is designed to operate at much higher frequencies, such as in FR2. Physically, the range of coverage is inversely proportional to the frequency used by the serving cell, as higher frequencies may result in stronger pathloss. Therefore, a serving cell using the FR2 may have a smaller range of coverage than a serving cell using the FR1. Additionally, performing the uplink transmissions at higher frequencies may be challenging due to the inherent limitations of battery-powered devices. For example, a PRACH may be subject to a higher pathloss, making it more difficult for the UEs to maintain an adequate success rate for the RA. RA failure is a critical issue that may significantly reduce the effectiveness of a cell coverage. That is, if the BS (e.g., gNB) is unable to receive and successfully decode the PRACH transmission from a UE, it may cause an RA failure. In the present disclosure, mechanisms for enhancing uplink transmission and signal transmission (including transmission on a PRACH) during the RA are provided. For example, the UE may be configured with a specific PRACH resource to support Multiple PRACH (MP) transmissions, which may increase the success rate of the PRACH reception on the BS side. These mechanisms may significantly increase the effectiveness of a cell coverage.

In the present disclosure, a transmission on a PRACH may refer to transmitting a (RA) preamble or any other signal on a PRACH.

In order to enhance the uplink transmission, an Enhanced Uplink Transmission (EUT) scheme that may be used by the UEs for uplink signal transmissions is provided. In the EUT scheme, a UE may, or may be indicated by a BS to, transmit a signal (e.g., including a TB/message/data) repeatedly to increase the success rate of the reception on the BS side. In other words, when using the EUT scheme, a UE may transmit a specific signal repeatedly in order to increase the success rate of the reception on the BS side. In a legacy system, this signal may only need to be transmitted once.

When the EUT scheme is applied to an RA procedure, it may be implemented by performing a PRACH transmission repeatedly. This may increase the success rate of the PRACH reception on the BS side. In some implementations, performing multiple PRACH transmissions (or, alternatively stated, performing a PRACH transmission repeatedly) means that the UE transmits an RA preamble repeatedly (e.g., multiple times) in each round of an RA preamble transmission step/stage during an ongoing RA procedure. For example, in a legacy system, a UE initiates an RA procedure and performs the RA resource selection. The UE then transmits an RA preamble only once (may be also referred to as a Single PRACH (SP) transmission) on the selected RA resource (e.g., in action 102 of FIG. 1). The UE then begins monitoring a DL channel (e.g., the PDCCH) for receiving a RAR that corresponds to the transmitted RA preamble (e.g., in action 104 of FIG. 1). If the BS is unable to successfully receive and/or decode the transmitted RA preamble, the UE will not receive the corresponding RAR from the BS. In such a case, the UE needs to perform a random backoff and perform the next round of RA resource selection and RA preamble transmission.

In some implementations, a random backoff may include: the UE receiving a backoff parameter/value from the BS, selecting a random backoff time, according to a uniform distribution between a specific value (e.g., 0) and the backoff parameter/value, and then delaying the subsequent RA preamble transmission by, at least, the random backoff time. The backoff parameter/value may be carried by a RAR.

When the EUT scheme is applied, the UE may transmit an RA preamble repeatedly or transmit multiple RA preambles in a round of RA preamble transmission step/stage after the RA resource selection. For example, when the EUT scheme is applied, the UE may transmit an RA preamble repeatedly before monitoring a DL channel (e.g., the PDCCH) for receiving a RAR corresponding the RA preamble. That is, the UE may perform a PRACH transmission repeatedly before the UE starts a configured time window for monitoring the DL channel for receiving the RAR corresponding to the RA preamble. In this way, the success rate of reception may be increased from the BS's perspective. In the present disclosure, performing a PRACH transmission repeatedly (or performing Multiple PRACH (MP) transmissions) may refer to transmitting any radio signal on a PRACH repeatedly in a round of RA preamble transmission step/stage of an RA procedure. The radio signal may include, but is not limited to, an RA preamble.

A UE may perform multiple PRACH transmissions to increase the success rate of the reception at the BS side. In addition, the terms “multiple radio signal transmissions on a PRACH,” “multiple PRACH transmissions,” and “MP transmissions” may be used interchangeably in the present disclosure.

In some implementations, if the UE has received an indication including a CFRA preamble index (e.g., ra-PreambleIndex, as defined in 3GPP TS 38.321 v16.7.0), the UE may not use the MP transmissions to transmit the RA preamble indicated by the CFRA preamble index.

In some implementations, once the UE has received an indication including a CFRA preamble index, the BS (e.g., gNB) may further indicate to the UE whether the UE needs to perform the MP transmissions for the RA preamble (e.g., a CFRA preamble) that is indicated by the CFRA preamble index. For example, whether the UE needs to perform the MP transmissions for the indicated RA preamble may be indicated by the gNB through an RRC configuration. The RRC configuration may include a dedicated RACH configuration (e.g., RACH-ConfigDedicated) or a beam failure recovery configuration for an SCell (e.g., BeamFailureRecoverySCellConfig). The RRC configuration may also include the CFRA preamble index. The RACH-ConfigDedicated may be an RRC parameter used to specify dedicated RA parameters. The BeamFailureRecoverySCellConfig may be an RRC parameter used to specify the configuration applied for beam failure recovery.

In some implementations, whether to apply the MP transmissions for an initiated RA procedure or not may depend on the RA preamble group selected by the UE. For example, if the UE selects an RA preamble group B (which may refer to a group of RA preambles configured by the BS, and the UE uses the RA preamble in this group to request a larger amount of uplink resources on a PUSCH for the MSG3 transmission) during the RA resource selection, the UE performs (or does not perform) the MP transmissions for the RA preamble. In some implementations, whether to apply the MP transmissions for a particular RA preamble group or not may be based on an indication received from the BS. For example, the UE may select an RA preamble from the RA preamble group B, but does not perform the MP transmissions for the RA preamble, since the BS indicates, to the UE, not to perform the MP transmissions through another indicator.

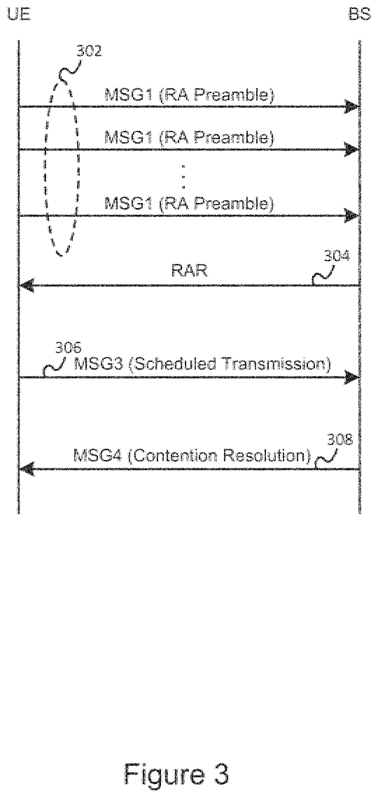

FIG. 3 is a sequence diagram illustrating an RA procedure with MP transmissions, according to an implementation of the present disclosure. As illustrated in FIG. 3, in action 302, the MP transmissions are performed (e.g., in a single round of RA preamble transmission step/stage). The MP transmissions may include a UE transmitting an MSG1 (which includes an RA preamble) multiple times (repeatedly) on a PRACH resource to a BS. Action 302 may be considered as being performed in (a round of) an RA preamble transmission step/stage of an RA procedure and before the UE begins monitoring a DL channel (e.g., the PDCCH) for receiving a RAR corresponding to the transmitted MSG1/RA preamble within a configured time window.

The UE may then begin monitoring a DL channel (e.g., the PDCCH) for receiving a RAR within a configured time window to see if a RAR corresponding to the transmitted MSG1 has been received. The configured time window may be determined by a timer. For example, once the timer starts, the configured time window begins; and once the timer stops or expires, the configured time window ends. If the UE does not receive the corresponding RAR within the configured time window, the UE may perform the next round of RA preamble transmissions step/stage. That is, the UE may perform action 302 again. In some implementations, in a new round of RA preamble transmissions step/stage, the UE may adjust at least one of the following factors to perform the PRACH transmission: the transmission power level, the RA resource, the RA preamble, the number of times the RA preamble should be transmitted in the round, and the beam.

In action 304, the BS may transmit a RAR to the UE in response to receiving the MSG1 from the UE. In action 306, after receiving the RAR, the UE may transmit an MSG3 to the BS in a scheduled transmission (e.g., scheduled by the RAR) by using a UL grant provided by the RAR. The UE then monitors a DL channel for receiving contention resolution to be received from the BS. In action 308, the UE may receive an MSG4 (e.g., contention resolution) from the BS. If the contention resolution is successful, the RA procedure ends.

In order to apply the EUT scheme to an RA procedure, the UE may be configured with at least one specific PRACH resource. The specific PRACH resource may be, but is not limited to be, configured by the BS (e.g., gNB) for an EUT scheme or the MP transmissions. If the specific PRACH resource is configured for (or specifically configured for) the MP transmissions, the specific PRACH resource may also be referred to as an MP-specific PRACH resource in the present disclosure.

In addition to a first PRACH resource configured for a legacy RA procedure (e.g., in which the PRACH/MSG1 transmission is implemented by an SP transmission), the UE may be further configured with a second PRACH resource that is specifically configured by the BS for the EUT scheme. In some implementations, the second PRACH resource may be independently configured and may be different from the PRACH resource(s) used in the legacy RA procedure (e.g., without applying the EUT scheme). In some implementations, depending on the availability of the PRACH resources, a PRACH resource configured for the EUT scheme may be used in a legacy RA procedure, such that the UE may also perform the SP transmission on the PRACH resource. A PRACH resource configured for a legacy RA procedure may be used in the EUT scheme, such that the UE may also perform the MP transmissions on the PRACH resource configured for the legacy RA procedure.

The legacy RA procedure may include, but is not limited to, the 4-step CBRA procedure and/or the 2-step CBRA procedure introduced in releases 15 and 16 of NR, respectively.

In some implementations, the PRACH resource configured for the EUT scheme may be configured by the BS via broadcast system information or a dedicated DL RRC message that is unicast from the BS to the UE (e.g., an RRC configuration message or an RRC release message with/without a suspend configuration).

However, performing the MP transmissions may increase both the power consumption and the latency for the RA procedure, as it requires a UE to transmit more uplink signals. Therefore, in some implementations, it may be more efficient for a UE to use the MP transmissions only when the channel condition, or the radio quality, is not good enough (e.g., the UE is located at the edge of a cell or has a low SINR). In other words, if the channel condition, or radio the quality, is good enough, it is expected that the BS should able to receive the RA preamble, as long as the UE performs a single PRACH transmission (e.g., SP transmission) without the UE needing to use the MP transmissions scheme. Therefore, in some implementations, a UE may be provided with one or more PRACH resources configured for the MP transmissions, and one or more PRACH resources for the SP transmission for legacy RA. The PRACH resource configured for the MP transmissions may also be referred to as an MP-specific PRACH resource in the present disclosure. Whether an initiated RA should apply the MP transmissions or the SP transmission may depend on different factors.

In the present disclosure, the term “MP transmissions” may refer to a UE performing multiple PRACH transmissions (or, stated alternately, a UE performing a PRACH transmission repeatedly) using any of the mechanisms/methods introduced in the present disclosure. On the other hand, the term “SP transmission” may refer to a UE performing a PRACH transmission, as in a legacy RA procedure (e.g., transmitting only a single RA preamble in each round of RA preamble transmission step/stage, like action 102 in FIG. 1). In some implementations, even if the UE uses a PRACH resource configured for the EUT scheme to transmit an RA preamble in an ongoing RA procedure, the RA preamble may still be transmitted on the PRACH only once in each round of RA preamble transmission step/stage of the ongoing RA procedure. That is, depending on the BS's implementation, the PRACH resource configured by the BS for the EUT scheme may explicitly or implicitly indicate to the UE whether it should perform a PRACH transmission only once in each round of RA preamble transmission step/stage.

In some implementations, a UE may perform an SP transmission on a PRACH resource even if the PRACH is configured for EUT (e.g., an MP-specific PRACH resource). For example, in each round of RA preamble transmission stage/step of an ongoing RA procedure, a UE may transmit an RA preamble on a PRACH resource configured for EUT only once. The BS may explicitly or implicitly indicate to a UE whether to use a PRACH resource configured for EUT to perform an SP transmission in each round of RA preamble transmission step/stage during an ongoing RA procedure.

To address the problem of increased power consumption and/or latency caused by the MP transmissions, a UE may only trigger the MP transmissions for an initiated RA procedure when one or more specific conditions are met.

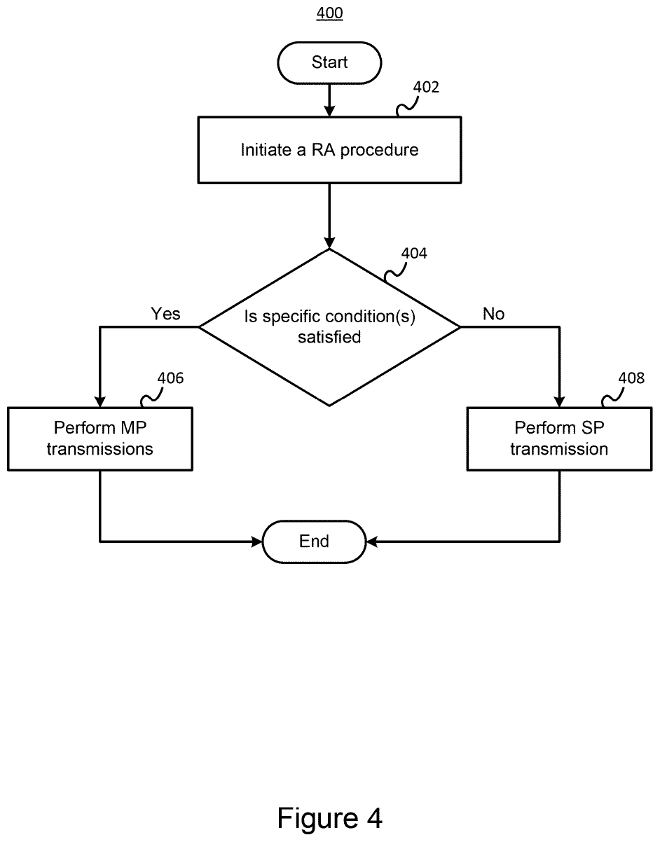

FIG. 4 is a flowchart illustrating method/process 400 for determining whether an initiated RA procedure uses an SP transmission or MP transmissions, according to an implementation of the present disclosure. Although actions 402, 404, 406, and 408 are illustrated, as separate actions, represented as independent blocks in FIG. 4, these separately illustrated actions should not be construed as to be necessarily order-dependent. The order in which the actions are performed in FIG. 4 is not intended to be construed as a limitation, and any number of the disclosed blocks may be combined in any order to implement the method, or an alternative method. Each of actions 402, 404, 406, and 408 may be performed independent of the other actions, and may be omitted in some implementations of the present disclosure. Moreover, method/process 400 may be combined with other procedures/methods described in the present disclosure. Process 400 may be performed by a UE. In action 402, process 400 may start by initiating an RA procedure. The RA procedure may be initiated for a certain purpose (e.g., initial access from an RRC_IDLE state to transition to an RRC_INACTIVE state). In action 404, process 400 may determine whether one or more specific conditions are satisfied. If the UE determines, in action 404, that the one or more specific condition are satisfied, in action 406, process 400 may perform the MP transmissions for the RA procedure (e.g., by transmitting an RA preamble for the RA procedure repeatedly before the UE begins monitoring a DL channel (e.g., the PDCCH) for receiving a RAR corresponding to the RA preamble, similar to action 302 of FIG. 3). If the UE determines, in action 404, that the one or more specific condition are not satisfied, in action 408, process 400 may perform an SP transmission to transmit the RA preamble.

In some implementations, even if the UE has determined to perform the MP transmissions for an initiated RA procedure, it is still possible that the UE switches to the SP transmission for the initiated RA procedure. For example, based on the RA procedure illustrated in FIG. 3, the UE may perform, in action 302, the MP transmissions for the initiated RA procedure. The determination of performing the MP transmissions may be in response to the UE determining that one or more specific conditions, for example, in action 404 of FIG. 4, are satisfied. If the UE does not receive a corresponding RAR for the transmitted PRACH/RA preamble, the UE may perform a random backoff and then retransmit the PRACH/RA preamble (in the next round of RA preamble transmission step/stage). Before the PRACH retransmission, the UE may check whether the one or more specific conditions are still satisfied. For example, the UE may perform DL RS measurements and compare the RSRP value of the DL RS(s) with a configured RSRP threshold. The UE may then determine whether to perform the MP transmissions for the retransmission of the PRACH based on the comparison's result. On the other hand, based on the RA procedure illustrated in FIG. 1, the UE may perform, in action 102, an SP transmission for the initiated RA procedure.

The determination of performing the SP transmission may be in response to the UE determining that one or more specific conditions, for example, in action 404 of FIG. 4, are not satisfied. If the UE does not receive a corresponding RAR for the transmitted PRACH/RA preamble, the UE may perform a random backoff and then retransmit the PRACH/RA preamble (in the next round of RA preamble transmission step/stage). Before the PRACH retransmission, the UE may check whether the one or more specific conditions are still not satisfied. For example, the UE may perform DL RS measurements and compare the RSRP value of the DL RS(s) with a configured RSRP threshold. The UE may then determine whether to perform the SP transmission for the retransmission of the PRACH based on the comparison's result. In some implementations, before the PRACH retransmission (or the next round of RA preamble transmission step/stage), the UE may also check whether another one or more specific conditions are satisfied, such as whether the UE has already performed the PRACH transmission a certain number of times.

The one or more specific conditions used in action 404 of FIG. 4 may include RS-measurement-based conditions, BS-indication based conditions, and/or UE-determination-based conditions. The one or more specific conditions may be based on whether the channel is considered as qualified or not.

In some implementations, a UE may be configured with an RSRP threshold for EUT (or RSRP_EUT) by a BS through DL signaling, which may be either a dedicated RRC message or broadcast system information. Once the UE initiates an RA procedure, the UE may perform the DL RS measurements. The UE may then determine whether to perform the MP transmissions or an SP transmission for the initiated RA procedure by performing a comparison procedure.

The comparison procedure may include the UE comparing the measurement result(s) of the DL RS(s) with the RSRP_EUT. The comparison procedure may further include the UE determining whether the measurement result(s) is equal to, or less than, the RSRP_EUT. In such a case, the specific condition(s) described in action 404 of FIG. 4 may include whether the measurement result(s) is equal to, or less than, the RSRP_EUT. If the measurement result(s) is less than the threshold, it may mean that the corresponding channel quality is not good enough, and thus the UE may decide to perform the MP transmissions for the initiated RA procedure. The measurement result may include an RSRP value of a DL pathloss RS, where the DL pathloss RS may refer to a DL RS transmitted by the BS, such as an SSB and/or a CSI-RS.

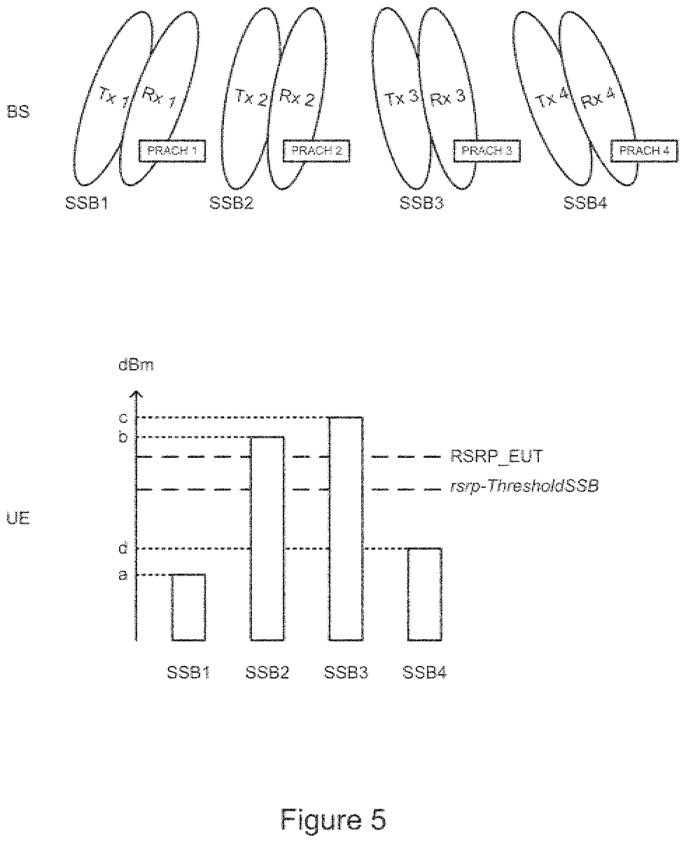

FIG. 5 is a diagram illustrating a comparison between the measurement results and the individual RSRP thresholds, according to an implementation of the present disclosure. As illustrated in FIG. 5, the BS may provide four DL beams (or Tx beams) and four UL beams (or Rx beams). Each DL beam may be one-to-one mapped to one UL beam. For example, DL beam Tx 1 may be paired with UL beam Rx 1, DL beam Tx 2 may be paired with UL beam Rx 2, and so on. A series of SSBs (e.g., SSB1, SSB2, SSB3, and SSB4) may be periodically transmitted via the DL beams. For example, SSB1 may be transmitted by DL beam Tx 1, SSB2 may be transmitted by DL beam Tx 2, and so on. In addition, the BS may configure the UE with at one or more PRACH resource configurations, each associated with an SSB or a DL beam. For example, as illustrated in FIG. 5, the PRACH configuration 1, PRACH 1, may be associated with SSB1, the PRACH configuration 2, PRACH 2, may be associated with SSB2, the PRACH configuration 3, PRACH 3, may be associated with SSB3, and the PRACH configuration 4, PRACH 4, may be associated with SSB4.

When a UE initiates an RA procedure, the UE may perform a PRACH resource selection procedure to select one of the configured PRACH configurations to use. The PRACH resource selection procedure may include the UE performing DL RS measurements on the SSBs and comparing each measurement result (e.g., each of the RSRP values of SSB1, SSB2, SSB3, and SSB4, which are denoted as a, b, c, and d, as shown in FIG. 5, respectively) with a specific RSRP threshold (e.g., rsrp-ThresholdSSB). The rsrp-ThresholdSSB may be an RSRP threshold configured by the BS for the purpose of SSB selection during an RA procedure, for example, as defined in 3GPP TS 38.321.

The UE may determine whether each of the measurement results (e.g., RSRP values a, b, c, and d) is equal to, or less than, the rsrp-ThresholdSSB. Only the PRACH resource indicated by the PRACH configuration associated with the SSB with an RSRP value equal to, or greater than, the rsrp-ThresholdSSB may be selected by the UE for the initiated RA procedure. For example, as illustrated in FIG. 5, only SSB2 and SSB3 have RSRP values greater than the rsrp-ThresholdSSB, and as such, only the PRACH configuration 2 (PRACH 2) and the PRACH configuration 3 (PRACH 3) (or the PRACH resource(s) derived from the PRACH configuration(s)) may be selected by the UE for the initiated RA procedure. The final selection between the PRACH configuration 2 and the PRACH configuration 3 may depend on the UE implementation.

The RSRP_EUT may be an RSRP threshold that is different from the rsrp-ThresholdSSB, as defined in 3GPP TS 38.321. As illustrated in FIG. 5, the RSRP_EUT may have a value greater than the rsrp-ThresholdSSB. In some implementations, the RSRP_EUT may have a value less than the rsrp-ThresholdSSB.

In some implementations, the PRACH resources associated with each SSB/Tx beam may be derived by the UE based on a PRACH configuration received by the UE. For example, the UE may derive at least one PRACH resource associated with SSB1 from PRACH 1, derive at least one PRACH resource associated with SSB2 from PRACH 2, derive at least one PRACH resource associated with SSB3 from PRACH 3, and derive at least one PRACH resource associated with SSB4 from PRACH 4. Each PRACH configuration (e.g., each of PRACH 1, PRACH 2, PRACH 3, and PRACH 4) may be indicated by the BS (e.g., gNB) through SIB1 or broadcast RRC message(s).

In some implementations, the UE may not be configured with the RSRP_EUT. In some such implementations, the UE may determine whether to perform the MP transmissions or the SP transmission for an initiated RA procedure based on the rsrp-ThresholdSSB. To reduce the implementation complexity and to avoid signaling overhead, the UE may be indicated by the BS to use a specific configured RSRP threshold, for example, rsrp-ThresholdSSB, as the RSRP_EUT, based on an indicator carried in a SIB carrying the RA configuration (e.g., SIB 1). In some implementations, the indicator may be a 1-bit indicator. For example, if the indicator is set to a first value (e.g., 1), the UE may use the rsrp-ThresholdSSB, as the RSRP_EUT, to determine whether to perform the MP transmissions or an SP transmission for an initiated RA procedure. Conversely, if the indicator is set to a second value (e.g., 0), the UE may directly choose the SP transmission for the initiated RA procedure. Alternatively, if the indicator is set to the second value, the UE may use another RSRP threshold, which is other than the rsrp-ThresholdSSB or the RSRP_EUT, to determine whether to perform the MP transmissions or an SP transmission for an initiated RA procedure. In some implementations, when the UE initiates an RA procedure, the UE may perform DL RS measurements and then determine whether to perform the MP transmissions or an SP transmission for the initiated RA procedure based on a comparison procedure that includes the UE comparing a measurement result with the rsrp-ThresholdSSB.

In some implementations, a UE may use the rsrp-ThresholdSSB to determine whether to perform the MP transmissions or an SP transmission only when the UE is not explicitly configured with an RSRP_EUT. For example, the UE may use the rsrp-ThresholdSSB to determine whether to perform the MP transmissions or an SP transmission only when the UE is not configured with an RSRP_EUT for a particular BWP (e.g., the current active BWP or the initial BWP). That is, if the UE is configured with an RSRP_EUT, the UE may use the RSRP_EUT to determine whether to perform the MP transmissions or an SP transmission; otherwise, the UE may use the rsrp-ThresholdSSB to determine whether to perform the MP transmissions or an SP transmission. In some implementations, the UE may apply the rsrp-ThresholdSSB for the determination of whether to perform the MP transmissions or an SP transmission only when the UE is not configured with an RSRP_EUT for a particular frequency band(s).

In some implementations, to reduce the signaling overhead, the UE may not be configured with the RSRP_EUT. In some such implementations, the UE may determine whether to perform the MP transmissions or an SP transmission for an initiated RA procedure based on an RSRP threshold configured by the BS for the MSG3 repetition. For example, the RSRP threshold may be applied by the UE to determine whether to apply a specific PRACH resource reserved for the UE to indicate to the BS (e.g., gNB) that the UE prefers performing the MSG3 repetition. Once the BS receives the preamble of the specific PRACH resource, the BS may schedule the UE to perform the MSG3 repetition. The MSG3 repetition may include the UE transmitting, repeatedly, an MSG3 for the initiated RA procedure in response to the UE receiving a RAR.

In some implementations, the specific condition(s) described in action 404 of FIG. 4 may include the following: the RSRO values of all of the detected DL RSs (e.g., SSBs and/or CSI-RSs) are less than, or equal to, a specific RSRP threshold (e.g., the rsrp-ThresholdSSB, the RSRP_EUT, or another configured RSRP threshold other than the rsrp-ThresholdSSB and the RSRP_EUT). That is, the UE may decide to perform the MP transmissions for the initiated RA in a case that the RSRP values of all of the detected DL RSs are less than, or equal to, the specific RSRP threshold.

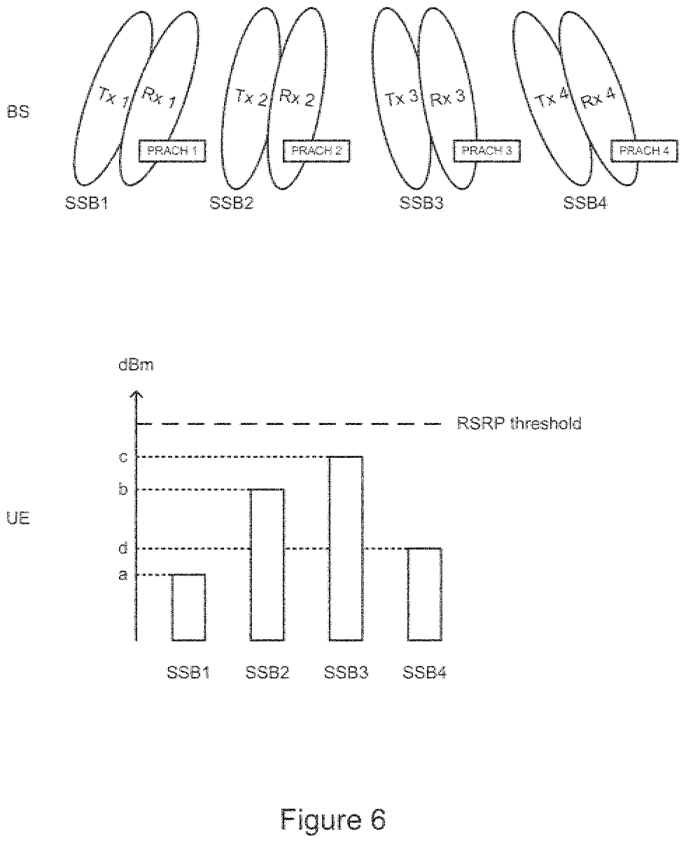

FIG. 6 is a diagram illustrating that all of the detected DL RSs have RSRP values less than a specific RSRP threshold, according to an implementation of the present disclosure. The specific RSRP threshold may be the rsrp-ThresholdSSB, the RSRP_EUT, or another configured RSRP threshold other than the rsrp-ThresholdSSB and the RSRP_EUT.

As illustrated in FIG. 6, the BS (e.g., gNB) may provide four DL beams (or Tx beams) and four UL beams (or Rx beams). Each DL beam may be one-to-one mapped to one UL beam. For example, DL beam Tx 1 may be paired with UL beam Rx 1, DL beam Tx 2 may be paired with UL beam Rx 2, and so on. A series of SSBs (e.g., SSB1, SSB2, SSB3, and SSB4) may be periodically transmitted via the DL beams. For example, SSB1 may be transmitted by DL beam Tx 1, SSB2 may be transmitted by DL beam Tx 2, and so on. In addition, the BS may configure the UE with one or more PRACH resource configurations, each associated with an SSB or a DL beam. For example, as illustrated in FIG. 6, the PRACH configuration, PRACH 1, may be associated with SSB1, the PRACH configuration 2, PRACH 2, may be associated with SSB2, the PRACH configuration 3, PRACH 3, may be associated with SSB3, and the PRACH configuration 4, PRACH 4, may be associated with SSB4. The UE may perform DL RS measurements to obtain the measurement results of the DL RSs (e.g., the RSRP values of SSB1, SSB2, SSB3, and SSB4, which are denoted as a, b, c, and d, as shown in FIG. 6, respectively). As shown in FIG. 6, all of the DL RSs (e.g., each of the SSB1, SSB2, SSB3, and SSB4) has an RSRP value less than the RSRP threshold. Hence, the UE may perform the MP transmissions for the initiated RA procedure (e.g., according to process 400 in FIG. 4).

In some implementations, only the DL RS(s) (e.g., SSB(s) or CSI-RS(s)) associated with the MP-specific PRACH resource(s) may be selected by the UE for an initiated RA procedure. For example, during the PRACH resource selection procedure for the initiated RA procedure, an MP-specific PRACH resource (e.g., indicated by a PRACH configuration) may be selected by the UE for the initiated RA procedure only when the MP-specific PRACH resource is associated with a DL RS with an RSRP value equal to, or less than, a corresponding RSRP threshold. In some implementations, a PRACH resource indicated by a PRACH configuration may be selected by the UE for the MP transmissions for an initiated RA procedure only when the PRACH resource is associated with an SSB with an RSRP equal to, or less than, a corresponding RSRP threshold, and the PRACH configuration may indicate at least one MP-specific PRACH resource.

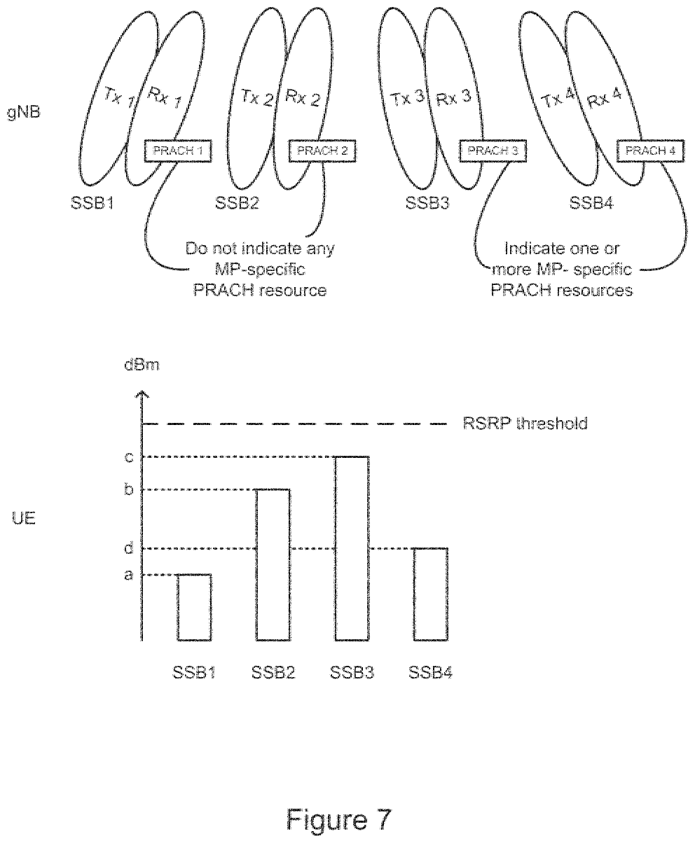

FIG. 7 is a diagram illustrating that all of the detected DL RSs have RSRP values less than a specific RSRP threshold, according to an implementation of the present disclosure. The specific RSRP threshold may be the rsrp-ThresholdSSB, the RSRP_EUT, or another configured RSRP threshold other than the rsrp-ThresholdSSB and the RSRP_EUT.

As illustrated in FIG. 7, the BS (e.g., gNB) may provide four DL beams (or Tx beams) and four UL beams (or Rx beams). Each DL beam may be one-to-one mapped to one UL beam. For example, DL beam Tx 1 may be paired with UL beam Rx 1, DL beam Tx 2 may be paired with UL beam Rx 2, and so on. A series of SSBs (e.g., SSB1, SSB2, SSB3, and SSB4) may be periodically transmitted via the DL beams. For example, SSB1 may be transmitted by DL beam Tx 1, SSB2 may be transmitted by DL beam Tx 2, and so on. In addition, the BS may configure the UE with one or more PRACH resource configurations, each associated with an SSB or a DL beam. For example, as illustrated in FIG. 7, the PRACH configuration, PRACH 1, may be associated with SSB1, the PRACH configuration 2, PRACH 2, may be associated with SSB2, the PRACH configuration 3, PRACH 3, may be associated with SSB3, and the PRACH configuration 4, PRACH 4, may be associated with SSB4. Furthermore, according to FIG. 7, only the PRACH configurations (e.g., PRACH 3 and PRACH 4) associated with SSB3 and SSB4 indicate MP-specific PRACH resources. The other two PRACH configurations (e.g., PRACH 1 and PRACH 2) associated with SSB1 and SSB2 do not indicate any MP-specific PRACH resources. For example, PRACH 3 and PRACH 4 indicate PRACH resources for both the MP transmissions and an SP transmission, while PRACH 1 and PRACH 2 indicate PRACH resources for an SP transmission only.

During the PRACH resource selection procedure, the UE may perform DL RS measurements to the SSBs (e.g., SSB1, SSB2, SSB3, and SSB4) and compare each measurement result (e.g., each of the RSRP values of SSB1, SSB2, SSB3, and SSB4, which are denoted as a, b, c, and d, as shown in FIG. 7, respectively) with a corresponding RSRP threshold. The RSRP threshold may be the rsrp-ThresholdSSB, the RSRP_EUT, or another configured RSRP threshold other than the rsrp-ThresholdSSB and the RSRP_EUT.

In some implementations, the UE may determine whether the RSRP values of the DL RSs (e.g., SSB1, SSB2, SSB3, and SSB4) are equal to, or less than, the RSRP threshold. As illustrated in FIG. 7, the RSRP values of all of the SSBs are less than the RSRP threshold. Therefore, the UE may perform the MP transmissions for the initiated RA procedure according to process 400 in FIG. 4. As described above, the UE may use a PRACH resource indicated by a PRACH configuration (e.g., PRACH 3 or PRACH 4 in FIG. 7) associated with an SSB (e.g., SSB3 or SSB4 in FIG. 7) with an RSRP value that is equal to, or less than, the RSRP threshold for the initiated RA procedure. That is, only the SSB associated with the PRACH configuration that indicates the MP-specific PRACH resource may be selected by the UE for the initiated RA procedure. Specifically, only in the case that a PRACH configuration indicates at least one MP-specific PRACH resource and the PRACH configuration is associated with an SSB with an RSRP value that is equal to, or less than, the RSRP threshold, the SSB may be selected by the UE for the MP transmissions for the initiated RA procedure. If the RSRP values of all of the SSBs are equal to, or less than, the RSRP threshold, but none of the PRACH configurations associated with these SSBs indicates an MP-specific resource, the UE may perform an SP transmission for the initiated RA procedure (e.g., according to process 400 in FIG. 4). In the example of FIG. 7, only the PRACH resources associated with SSB 3 and SSB 4 may be selected by the UE for the MP transmissions. For example, the UE may select either the PRACH resource associated with SSB 3 or the PRACH resource associated with SSB 4 to be used for the MP transmissions (e.g., based on the UE's implementation).

In some implementations, among the PRACH resources associated with SSB 3 and SSB 4, the UE may select the PRACH resource associated with the SSB with the higher RSRP value to be used for the MP transmissions. In such a case, the PRACH resource associated with SSB3 may be selected to be used for the MP transmissions since SSB3 has a higher RSRP value (which is denoted as c in FIG. 7) than the RSRP value of SSB4 (which is denoted d in FIG. 7). In some implementations, among the PRACH resources associated with the SSBs having RSRP values less than the RSRP threshold (e.g., SSB 3 and SSB 4 in FIG. 7), the UE may select the PRACH resource associated with the SSB with the highest/largest RSRP value to be used for the MP transmissions. In some implementations, among the PRACH resources associated with SSBs having RSRP values less than the RSRP threshold and not configured with an MP-specific PRACH resource, the UE may select the PRACH resource that supports the most transmission times to use.

For the MP transmissions, the UE may perform a PRACH transmission a certain number of times (which is also referred to as Np value in the present disclosure) on a configured PRACH resource. The Np value may be explicitly or implicitly determined by the UE according to the configured PRACH resource. For example, a PRACH resource associated with a different SSB may indicate to the UE a different Np value. In some implementations, the UE may select the PRACH resource associated with a particular SSB based on the Np value determined for each SSB. In addition, the PRACH resource supporting more transmission times in the frequency/time domain may refer to the PRACH resource indicating to the UE an Np value with the largest value among all of the Np values associated with all SSBs. In some implementations, according to FIG. 7, the UE may select among the PRACH resources associated with SSB3 and SSB4 (i.e., the SSBs associated with MP-specific PRACH resources), and the PRACH resource associated with the SSB with the highest/largest SSB index will be selected by the UE.

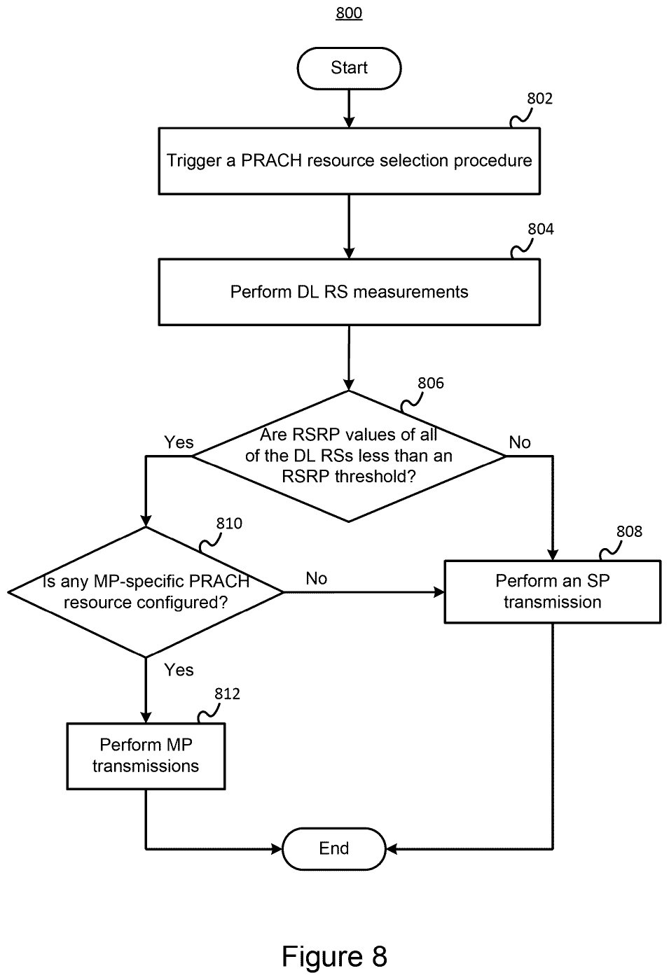

FIG. 8 is a flowchart illustrating process/method 800 performed by a UE to determine whether to perform MP transmissions or to perform an SP transmission, according to an implementation of the present disclosure. Although actions 802, 804, 806, 808, 810, and 812 are illustrated, as separate actions, represented as independent blocks in FIG. 8, these separately illustrated actions should not be construed as to be necessarily order-dependent. The order in which the actions are performed in FIG. 8 is not intended to be construed as a limitation, and any number of the disclosed blocks may be combined in any order to implement the method, or an alternative method. Each of actions 802, 804, 806, 808, 810, and 812 may be performed independent of the other actions, and may be omitted in some implementations of the present disclosure. Moreover, method/process 800 may be combined with other procedures/methods described in the present disclosure. As illustrated in FIG. 8, once a UE initiates an RA procedure, the UE may trigger, in action 802, a PRACH resource selection procedure, and perform, in action 804, DL RS measurements to obtain the RSRP values of the DL RSs (e.g., SSBs or CSI-RSs). The UE may then determine, in action 806, whether the RSRP values of all the DL RSs are less than an RSRP threshold. The threshold may be the EUT_RSRP, the rsrp-ThresholdSSB, or any other RSRP threshold configured by the BS.

In some implementations, the RSRP threshold may be an RSRP threshold configured by the BS before the UE initiates the RA procedure. If there is at least one DL RS with an RSRP value greater than, or equal to, the RSRP threshold, the UE may perform, in action 808, an SP transmission for the initiated RA procedure. If there is no DL RS with an RSRP value greater than, or equal to, the RSRP threshold, the UE may further determine, in action 810, whether there is any MP-specific PRACH resource configured to be associated with the DL RSs. If there is at least one MP-specific PRACH resource configured to be associated with at least one DL RS (or at least one of the DL RSs is associated with an MP-specific PRACH resource), the UE may perform, in action 812, the MP transmissions on a selected MP-specific PRACH resource for the initiated RA procedure. Otherwise, if there is no MP-specific PRACH resource configured to be associated with the DL RSs, the UE may then perform the SP transmission for the initiated RA in action 808.

In some implementations, the UE may be configured with the RSRP_EUT and another RSRP threshold (e.g., RSRP_EUTSSB) for the SSB/CSI-RS selection within an RA resource selection procedure. The RSRP_EUT may be applied by the UE to determine whether to perform the MP transmissions or an SP transmission for an initiated RA procedure, while the RSRP_EUTSSB is being applied by the UE to select the PRACH/RA resources (or configurations). An overall RA resource selection procedure may be divided into two stages. In the first stage, the UE may determine whether to perform the MP transmissions or the SP transmission for the initiated RA procedure based on a comparison between a measurement result (e.g., an RSRP value of a DL RS) and the RSRP_EUT. Once the UE decides to perform the MP transmissions for the initiated RA procedure, in the second stage, the UE may select a PRACH resource for the MP transmissions according to the RSRP_EUTSSB.

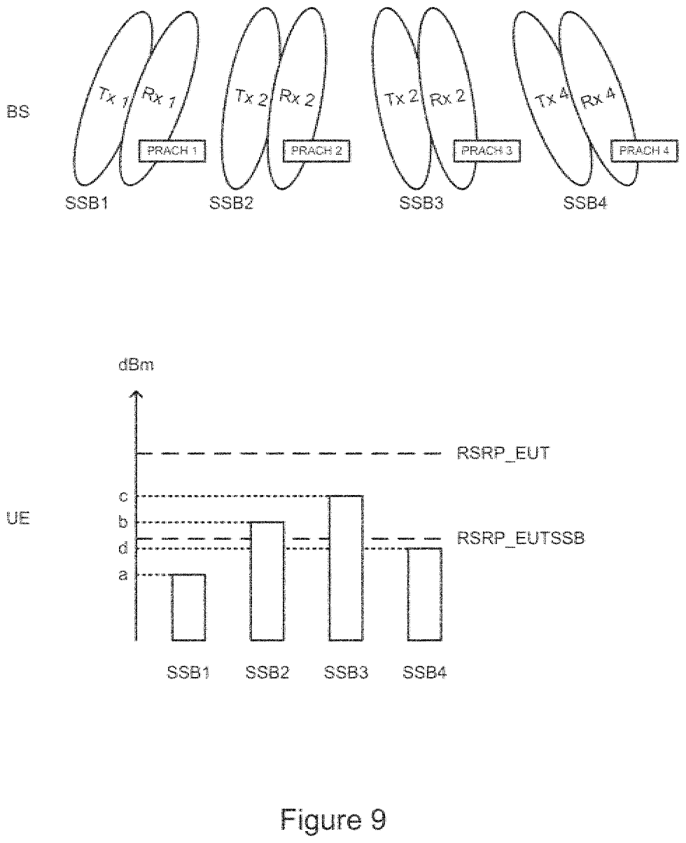

FIG. 9 is a diagram illustrating that the decision to perform MP transmissions and the selection of the PRACH resource for the MP transmissions are based on the RSRP_EUT and RSRP_EUTSSB, according to an implementation of the present disclosure. As illustrated in FIG. 9, the BS may provide four DL beams (or Tx beams) and four UL beams (or Rx beams). Each DL beam may be one-to-one mapped to one UL beam. For example, DL beam Tx 1 may be paired with UL beam Rx 1, DL beam Tx 2 may be paired with UL beam Rx 2, and so on. A series of SSBs (e.g., SSB1, SSB2, SSB3, and SSB4) may be periodically transmitted via the DL beams. For example, SSB1 may be transmitted by DL beam Tx 1, SSB2 may be transmitted by DL beam Tx 2, and so on. In addition, the BS may configure the UE with one or more PRACH resource configurations, each associated with an SSB or a DL beam. For example, as illustrated in FIG. 9, the PRACH configuration 1, PRACH 1, may be associated with SSB1, the PRACH configuration 2, PRACH 2, may be associated with SSB2, the PRACH configuration 3, PRACH 3, may be associated with SSB3, and the PRACH configuration 4, PRACH 4, may be associated with SSB4.

The UE may perform the DL RS measurements to obtain the measurement results of the SSBs/DL pathloss RSs (e.g., the RSRP values of SSB1, SSB2, SSB3, and SSB4, which are denoted as a, b, c, and d, as shown in FIG. 9, respectively). If the RSRP values (e.g., a, b, c, and d, as denoted in FIG. 9) of all of SSBs/DL pathloss RSs (e.g., SSB1, SSB2, SSB3, and SSB4) are less than the RSRP_EUT, the UE may apply the MP transmissions for the initiated RA procedure. The UE may then prioritize the selection of the PRACH resource(s) associated with the SSB(s) with an RSRP value equal to, or greater than, the RSRP_EUTSSB (e.g., SSB 2 and SSB 3 in FIG. 9). That is, the UE may select a PRACH resource for the MP transmissions from the PRACH resource(s) associated with the SSB(s) having an RSRP value equal to, or greater than, the RSRP_EUTSSB.

In some implementations, in order to enhance the uplink transmissions for an RA procedure, a UE may not only perform the MP transmissions for transmitting the MSG1, but also perform multiple PUSCH transmissions for transmitting the MSG3. The multiple PUSCH transmissions are also referred to as MSG3 repetitions or multiple MSG3 transmissions in the present disclosure. That is, the terms “MSG3 repetitions,” “multiple MSG3 transmissions,” and “multiple PUSCH transmissions” may be used interchangeably in the present disclosure.

Since the uplink radio resource for the MSG3 transmission may be dynamically scheduled by the BS (e.g., gNB), letting the BS understand the corresponding channel condition in advance may be advantageous. For example, once the BS is aware of the channel condition, the BS may determine to schedule the UE to perform multiple MSG3 transmissions accordingly. For example, to avoid wasting the uplink resources, the BS may inform the UE of the number of times the UE needs to transmit the MSG3 (e.g., in action 104 of FIG. 1 or action 304 of FIG. 3). The UE may then follow the instruction received from the BS and transmit the MSG3 the specified number of times (e.g., in action 106 of FIG. 1 or action 306 of FIG. 3).

The number of times the UE needs to transmit the MSG3 may be dynamically determined by the BS, according to the corresponding channel situation. In some implementations, the BS may configure the UE with at least two PRACH configurations, where one of the at least two PRACH configurations may be applied by the UE when the corresponding channel condition is qualified, and the other one of the at least two PRACH configurations may be applied by the UE when the corresponding channel condition is not qualified. In some implementations, whether the corresponding channel condition is qualified or not may be determined based on a comparison between a measurement result and a pre-configured RSRP threshold (e.g., RSRP_MSG3). The RSRP_MSG3 may be configured by the BS through a dedicated RRC message or broadcast system information. For example, if the measurement result is equal to, or less than, the RSRP_MSG3, it may imply that the corresponding channel quality does not meet the required quality. Therefore, by performing/triggering the MSG3 repetitions during the RA procedure, the success rate of the RA procedure may be substantially increased.

In some implementations, the RSRP_MSG3 may be applied by the UE to determine whether to perform the MP transmissions or an SP transmission for the initiated RA procedure. For example, the UE may not explicitly be configured with the RSRP_EUT and/or the RSRP_EUTSSB, as discussed above, but may use the RSRP_MSG3 to implement the function of the RSRP_EUT and/or the RSRP_EUTSSB. That is, the UE may apply the RSRP_MSG3 as the RSRP_EUT and/or the RSRP_EUTSSB. For example, if the UE is not explicitly configured with the RSRP_EUT and/or the RSRP_EUTSSB, the UE may apply/reuse a configured RSRP_MSG3, as the RSRP_EUT and/or the RSRP_EUTSSB, to determine whether to perform the MP transmissions or an SP transmission for the initiated RA procedure. In some implementations, if the UE is not explicitly configured with the RSRP_MSG3, the UE may apply/reuse the configured RSRP_EUT and/or RSRP_EUTSSB, as RSRP_MSG3, to determine whether to request the MSG3 repetitions or not for the initiated RA procedure.

In some implementations, for the MP transmissions for the EUT scheme, the UE may be configured with multiple RSRP thresholds that need to be checked during an initiated RA procedure. For example, the multiple RSRP thresholds may include a threshold for determining whether the initiated RA procedure should be a 2-step or a 4-step RA procedure, and a threshold for determining whether the initiated RA procedure should be performed on a particular uplink carrier (e.g., SUL). In some implementations, once the UE initiates an RA procedure, the UE may first determine whether to perform the MP transmissions for the RA procedure, according to an RSRP threshold configured for the corresponding determination. Once the UE determines to perform the MP transmissions for the initiated RA procedure, the UE may skip checking whether the initiated RA procedure should be a 2-step or a 4-step RA procedure and/or may skip checking whether the initiated RA procedure should be performed on a particular uplink carrier (e.g., SUL). For example, once the UE determines to perform the MP transmissions for the initiated RA procedure, the UE may perform the 4-step RA procedure and/or may perform the RA procedure on a particular uplink carrier (e.g., SUL), without additional checking based on certain RSRP threshold(s).

In some implementations, the UE may determine whether to perform the MP transmissions or an SP transmission based on one or more indicators received from the BS (e.g., gNB).

In some implementations, the one or more indicators may be carried by a RAR corresponding to an RA preamble transmission of an initiated RA procedure. For example, after initiating an RA procedure, the UE may perform an SP transmission to transmit an RA preamble for the initiated RA procedure. Once the UE receives a RAR corresponding to the transmitted RA preamble, the UE may be indicated by the BS to perform a random backoff and to perform the MP transmissions for the subsequent RA preamble transmission(s) after the random backoff. Furthermore, the indicator may further indicate to the UE which PRACH resource to be used for the MP transmissions. The indicated PRACH resource may be allocated in a UL BWP different from the current active UL BWP (e.g., initial UL BWP). The indicator may be carried by a MAC subheader of a MAC PDU of the RAR.

In some implementations, the indicator may be implemented implicitly. For example, once the UE initiates an RA procedure, the UE may first perform an SP transmission for the initiated RA procedure. Afterward, the UE may monitor a DL channel (e.g., the PDCCH) for receiving the RAR from the BS. If the UE does not receive a corresponding RAR (e.g., indicating an RA preamble identity associated with the transmitted RA preamble), the UE may perform a random backoff and then perform the MP transmissions for the subsequent RA preamble transmission after the backoff. That is, the UE may perform a random backoff and perform the MP transmissions for the subsequent RA preamble transmission after the backoff if the UE does not receive a RAR that contains an RA preamble identifier that matches the transmitted RA preamble within a configured time window (which is also referred to as a RAR window).

In some implementations, after the UE initiates an RA procedure, the UE may first perform an SP transmission for the initiated RA procedure. Then, the UE may monitor a DL channel (e.g., the PDCCH) for receiving the RAR from the BS. If the UE does not receive a RAR that indicates the RA preamble identity associated with the transmitted RA preamble within a configured time window a certain number of times (e.g., K times), the UE may perform a random backoff and perform the MP transmissions for the subsequent RA preamble transmission after the backoff. For example, the UE may perform an SP transmission for the initiated RA procedure, and after a certain number (e.g., K) of RA preamble retransmissions (through the random backoff), the UE may switch to perform the MP transmissions until the RA procedure is either successfully completed or fails. In some implementations, the number K may be a value configured by the BS through an RRC configuration. In some implementations, if the UE does not receive a RAR that indicates the RA preamble identity associated with the transmitted RA preamble a certain number (e.g., K) of times, the UE may perform the MP transmissions for the subsequent RA preamble transmission using the maximum transmission power. The number K may be one, or greater than one, and may be configured as part of the PRACH resource configuration. In some implementations, the random backoff may not be necessary (e.g., the random backoff may be skipped) when the UE switches from the SP transmission to the MP transmissions, since the PRACH resource for the SP transmission and the MP transmissions may be different.

In some implementations, once a UE receives a RAR indicating to the UE to perform the MSG3 repetitions for the scheduled MSG3 transmission, the UE may perform the MP transmissions once the UE performs a random backoff after the MSG3 repetitions (e.g., when the UE does not successfully complete the contention resolution).

In some implementations, the indicator may be carried by the DCI that has scheduled the RAR for an RA preamble transmission of an initiated RA procedure.

In some implementations, when the contention resolution fails, the UE may perform the MP transmissions.

In some implementations, in order to indicate a large number of UEs, while avoiding signaling overhead, the indicator may be transmitted by the BS (e.g., gNB) through broadcast system information. The indicator may be configured on a per-serving-cell basis or on a per-BWP-basis. That is, an indicator may indicate to all the UEs of a serving cell whether the MP transmissions for an RA is prohibited or needed. In some implementations, the UE may be indicated whether the MP transmissions for an initiated RA procedure are allowed or not by the BS via at least one SIB. For example, before initiating an RA procedure, the UE may check whether an access category is allowed by the BS for triggering an RA procedure. The UE may be indicated by the BS whether one or more particular access categories require the MP transmissions for the corresponding RA procedure.

In some other implementations, while the UE is in an RRC_CONNTED state, the UE may be configured with at least one MP-specific PRACH resource via an RRC Release message (e.g., RRCRelease). The RRC Release message may indicate to the UE to transition from the RRC_CONNECTED state to an RRC_IDLE state or an RRC_INACTIVE state. Afterward, the UE may need to perform the MP transmissions for an RA procedure initiated by the UE for an RRC resume, or for transitioning from the RRC_IDLE state to the RRC_CONNECTED state. Alternatively, the UE may perform an SP transmission for the initiated RA procedure if the UE is not configured with any MP-specific PRACH resource (e.g., via the RRCRelease message).

In some implementations, there may be one or more predefined rules that the UE needs to follow once the UE initiates an RA procedure.

In some implementations, the UE may determine to perform either the MP transmissions or an SP transmission for an initiated RA procedure, according to the purpose of triggering the RA procedure. For example, the UE may perform the MP transmissions for the initiated RA procedure if the RA procedure is triggered for a beam failure recovery, a system information request, a handover and/or secondary gNB/cell addition. In some implementations, the UE may be explicitly indicated by the BS to perform the MP transmissions for the initiated RA procedure through one or more specific PRACH configurations. For example, the UE may be explicitly configured by the BS with a beam-failure-recovery-specific PRACH configuration. The beam-failure-recovery-specific PRACH configuration may be applied by the UE for an initiated RA procedure if the RA procedure is initiated for the beam failure recovery. During the beam failure recovery procedure, the UE may receive from the BS an indicator indicating whether the UE should perform the MP transmissions for the initiated RA procedure. The indicator may include, but is not limited to, an MP-specific PRACH configuration or an MP-specific RRC parameter.

As described above, many mechanisms have been introduced to enhance the uplink transmissions for an RA procedure by supporting multiple transmissions of MSG1 and/or MSG3. However, these mechanisms may be applied independently by the UE for the MSG1 and MSG3 transmissions. The BS (e.g., gNB) may indicate to the UE to perform multiple MSG3 transmissions through a UL Grant field within the RAR. In some implementations, the UE may be indicated to perform multiple MSG3 transmissions through one or more bits in the MCS information within the UL Grant field. The BS may use the one or more bits to indicate to the UE how many times the UE should transmit the scheduled MSG3 for the MSG3 repetitions. If the UE determines that the BS has not indicated to the UE to perform the MSG3 repetitions, once the UE is configured with at least one MP-specific PRACH resource, the UE may interpret all of the bits in the MCS information within the UL Grant field, as being used for indicating one of the MCS configurations preconfigured by RRC. On the other hand, if the UE determines that the BS has indicated to the UE to perform the MSG3 repetitions, once the UE is configured with at least one MP-specific PRACH resource, the UE may interpret only a part of the bits in the MCS information within the UL Grant field as being used for indicating one of the MCS configurations preconfigured by RRC, and the rest of the bits for indicating how many times the UE should transmit the scheduled MSG3 for the MSG3 repetitions.

Although triggering of the MSG3 repetitions (or multiple MSG3 transmissions) may depend on the triggering of the MP transmissions, it may be difficult to for the UE predict whether to perform the MSG3 repetitions correctly, because whether to perform the MP transmissions may depend on the measurement results and whether an MP-specific PRACH resource is configured. Therefore, it may be difficult for the UE to predict whether the BS has indicated to the UE to perform the MSG3 repetitions in response to the triggering of the MP transmissions. To address this problem, in some implementations the UE may always assume that the BS has indicated to the UE to perform multiple MSG3 transmissions, as long as the UE applies the MP transmissions. In addition, to prevent unsynchronized behavior between the BS and the UE, and to reduce the signaling overhead, once a UE initiates an RA procedure, the UE may always assume that the BS will indicate how many times the UE should transmit the scheduled MSG3 for the MSG3 repetitions. That is, the UE may always assume that the number of times the UE should transmit the scheduled MSG3 for the MSG3 repetitions may be indicated by the BS through the RAR. For example, the UE may always interpret a part of the bits of the MCS information within the UL Grant field, as indicating how many times the UE should transmit the scheduled MSG3 for the MSG3 repetitions.

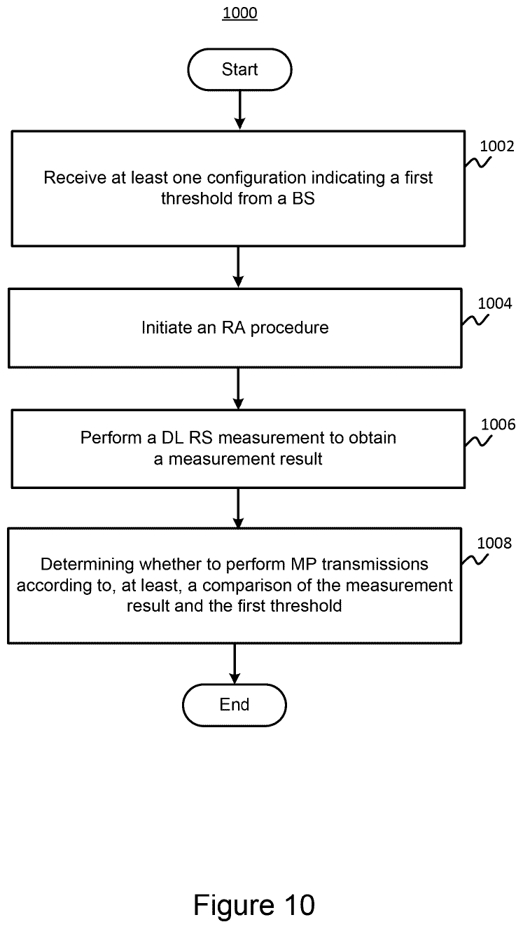

FIG. 10 is a flowchart illustrating method/process 1000 for performing uplink transmissions, according to an example implementation of the present disclosure. Although actions 1002, 1004, 1006, and 1008 are illustrated, as separate actions, represented as independent blocks in FIG. 10, these separately illustrated actions should not be construed as to be necessarily order-dependent. The order in which the actions are performed in FIG. 10 is not intended to be construed as a limitation, and any number of the disclosed blocks may be combined in any order to implement the method, or an alternative method. Each of actions 1002, 1004, 1006, and 1008 may be performed independent of the other actions, and may be omitted in some implementations of the present disclosure. Moreover, method/process 1000 may be combined with other procedures/methods described in the present disclosure. Method/process 1000 may be performed by a UE.

In action 1002, method 1000 may start by receiving at least one configuration indicating a first threshold from a BS. The first threshold may be any of the RSRP thresholds described in the present disclosure, such as RSRP_EUT, rsrp-ThresholdSSB, RSRP_EUTSSB, RSRP_MSG3, or any other configured RSRP threshold.

In action 1004, method 1000 may initiate an RA procedure.

In action 1006, method 1000 may perform a DL RS measurement to obtain a measurement result. For example, according to FIG. 5, 6, 7, or 9, the UE may perform a DL RS measurement on each DL RS (e.g., each of SSB1, SSB2, SSB3, and SSB4 in FIG. 5, 6, 7, or 9), and may obtain the corresponding measurement results of these DL RSs (e.g., the RSRP values of SSB1, SSB2, SSB3, and SSB4).

In action 1008, method 1000 may determine whether to perform the MP transmissions according to, at least, a comparison between the measurement result and the first threshold. For example, according to action 404 of FIG. 4, the UE may perform the MP transmissions when one or more specific conditions are satisfied, where the one or more specific conditions may be based on a comparison between the measurement result and the first threshold. Method 1000 may then end.

The MP transmissions may include the UE transmitting, repeatedly, an RA preamble for the RA procedure before the UE begins monitoring a DL channel (e.g., the PDCCH) for receiving a RAR that corresponds to the RA preamble. For example, according to FIG. 3, the UE may transmit the RA preamble a certain number of times in action 302, where action 302 may occur before the UE begins monitoring a DL channel (e.g., the PDCCH) for receiving the corresponding RAR in action 304. In some implementations, a RAR that corresponds to an RA preamble may include a RAR that includes an RA preamble identity associated with the RA preamble.

In some implementations, the measurement result may include at least one RSRP value of at least one DL RS. Method 1000 may further include performing a set of operations after determining that all the at least one RSRP value is less than the first threshold. The set of operations may include the UE determining whether the at least one DL RS is associated with at least one MP-specific PRACH resource that is configured for the UE to perform the MP transmissions, and performing the MP transmissions after determining that the at least one DL RS is associated with the at least one MP-specific PRACH resource. For example, according to FIG. 8, the UE may perform a set of operations (e.g., actions 810 and 812) after determining that the RSRP values of all the DL RSs are less than an RSRP threshold. Specifically, the UE may further determine, in action 810, whether any MP-specific PRACH resource is configured after determining that the RSRP values of all the DL RSs are less than an RSRP threshold, and if the UE determines, in action 810, that any MP-specific PRACH resource is configured, in action 812, the UE may then perform the MP transmissions.

In some implementations, the set of operations may further include performing an SP transmission after determining that none of the at least one DL RS is associated with the at least one MP-specific PRACH resource. For example, according to FIG. 8, the UE may perform an SP transmission, in action 808, after determining that no MP-specific PRACH resource is configured and/or none of the DL RSs is associated with an MP-specific PRACH resource, for example, in action 810.

The SP transmission may include (or consist of) the UE transmitting the RA preamble for the RA procedure only once before the UE begins monitoring a DL channel (e.g., the PDCCH) for receiving the RAR that corresponds to the RA preamble. For example, according to FIG. 1, the UE may transmit the RA preamble only once in action 102, where action 102 may occur before the UE begins monitoring a DL channel (e.g., the PDCCH) for receiving the corresponding RAR in action 104.

In some implementations, the set of operations may further include selecting an MP-specific PRACH resource, among the at least one MP-specific PRACH resource, for transmitting the RA preamble. For example, according to FIG. 6, 7, or 9, the UE may still select an MP-specific PRACH resource for an initiated RA procedure even if the RSRP values of all the DL RSs are less than a specific RSRP threshold.

In some implementations, method 1000 may further include the UE performing the MP transmissions after determining that the measurement result is less than the first threshold, and performing an SP transmission after determining that the measurement result is equal to, or greater than, the first threshold. For example, according to FIG. 4, the one or more specific conditions in action 404 may include whether the measurement result of a DL RS is less than an RSRP threshold. If the UE determines, in action 404, that the one or more specific conditions are satisfied, in action 406, the UE may perform the MP transmissions. If the UE determines, in action 404, that the one or more specific conditions are not satisfied, in action 408, the UE may perform an SP transmission.

In some implementations, method 1000 may further include selecting a PRACH resource for transmitting the RA preamble, according to a comparison between the measurement result and the first threshold.

In some implementations, method 1000 may further include selecting a PRACH resource for transmitting the RA preamble according to a comparison between the measurement result and a second threshold, where the first threshold and the second threshold are independently indicated by the at least one configuration. For example, according to FIG. 5, the first threshold and the second threshold may correspond to the RSRP_EUT and the rsrp-ThresholdSSB; and according to FIG. 9, the first threshold and the second threshold may correspond to the RSRP_EUT and the RSRP_EUTSSB.

In some implementations, method 1000 may further include the UE receiving, from the BS, an indication of whether a second threshold is used, as the first threshold, where the second threshold is configured for the UE to select a PRACH resource for transmitting the RA preamble. For example, as described above, to reduce the implementation complexity and to avoid the signaling overhead, the UE may be indicated by the BS to use a specific configured RSRP threshold, for example, rsrp-ThresholdSSB, as the RSRP_EUT, based on a specific indicator.

In some implementations, method 1000 may further include determining whether to indicate to the BS that the UE is capable of performing the MSG3 repetitions, according to the first threshold. The MSG3 repetitions may include the UE transmitting, repeatedly, an MSG3 for the RA procedure after the UE receives the RAR.

It should be noted that although method 1000 may be described with reference to certain figures of the present disclosure, it does not mean that method 1000 is intended to be restricted to the implementations/embodiments illustrated in these figures. As described above, method 1000 may correspond to, or be combined with, other procedures or methods related to the MP transmissions that are described in the present disclosure.

According to method 1000, the UE may be enabled to determine whether to perform the MP transmissions based on the measurement result of the DL RS(s) and one or more specific RSRP thresholds, thus optimizing the timing of applying the MP transmissions, reducing the potential delay and power consumption caused by the MP transmissions, and improving the performance of the EUT scheme.

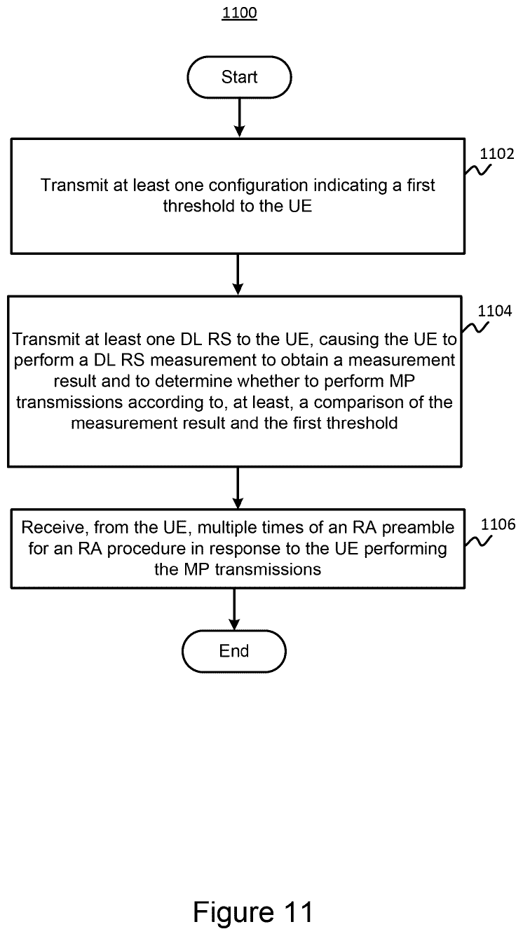

FIG. 11 is a flowchart illustrating method/process 1100 for communicating with a UE that is performing uplink transmissions, according to an example implementation of the present disclosure. Although actions 1102, 1104, and 1106 are illustrated, as separate actions, represented as independent blocks in FIG. 11, these separately illustrated actions should not be construed as to be necessarily order-dependent. The order in which the actions are performed in FIG. 11 is not intended to be construed as a limitation, and any number of the disclosed blocks may be combined in any order to implement the method, or an alternative method. Each of actions 1102, 1104, and 1106 may be performed independent of the other actions, and may be omitted in some implementations of the present disclosure. Moreover, method/process 1100 may be combined with other procedures/methods described in the present disclosure. Method/process 1100 is a process executed from the perspective of the BS, and it may be considered as corresponding to method 1000 which is executed from the perspective of the UE. Method/process 1100 may be performed by a BS.

In action 1102, method 1100 may start by transmitting at least one configuration, indicating a first threshold, to the UE.

In action 1104, method 1100 may transmit at least one DL RS to the UE, causing the UE to perform a DL RS measurement to obtain a measurement result and to determine whether to perform the MP transmissions according to, at least, a comparison between the measurement result and the first threshold.

In action 1106, method 1100 may receive, repeatedly, from the UE, an RA preamble for an RA procedure in response to the UE performing the MP transmissions. The MP transmissions may include the UE transmitting, repeatedly, an RA preamble for the RA procedure before the UE begins monitoring a DL channel (e.g., the PDCCH) for receiving a RAR that corresponds to the RA preamble. For example, according to FIG. 3, the UE may transmit the RA preamble a certain number of times in action 302, where action 302 may occur before the UE begins monitoring a DL channel (e.g., the PDCCH) for receiving the corresponding RAR in action 304. In some implementations, a RAR that corresponds to an RA preamble may refer to a RAR that includes an RA preamble's identity associated with the RA preamble. Method 1100 may then end.

In some implementations, the BS may transmit an indication of whether a second threshold is used as the first threshold to the UE, where the second threshold may be configured for the UE to select a PRACH resource for transmitting the RA preamble. For example, as described above, to reduce the implementation complexity and to avoid the signaling overhead, the BS may indicate to the UE, through a specific indicator/indication, that a specific configured RSRP threshold, for example, rsrp-ThresholdSSB, should be used as the RSRP_EUT.

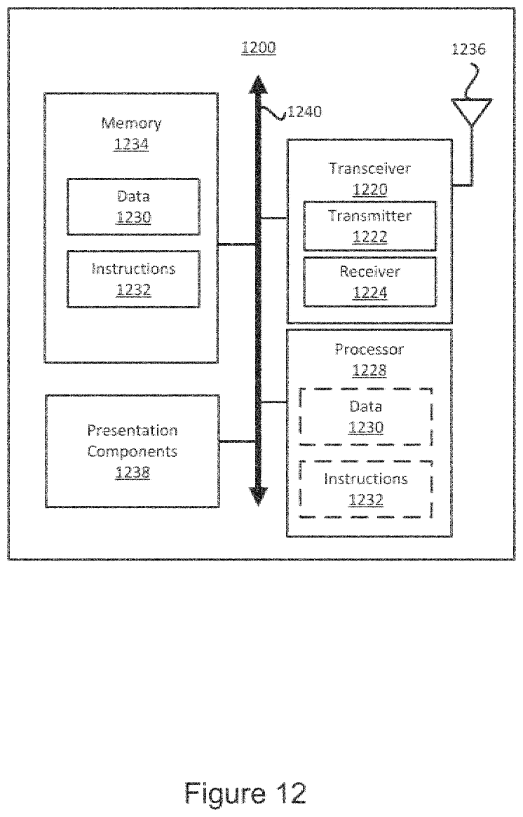

FIG. 12 is a block diagram illustrating node 1200 for wireless communication, according to an example implementation of the present disclosure. As illustrated in FIG. 12, node 1200 may include transceiver 1220, processor 1228, memory 1234, one or more presentation components 1238, and at least one antenna 1236. Node 1200 may also include a radio frequency (RF) spectrum band module, a BS communications module, a network communications module, and a system communications management module, Input/Output (I/O) ports, I/O components, and a power supply (not illustrated in FIG. 12).

Each of the components may directly or indirectly communicate with each other over one or more buses 1240. Node 1200 may be a UE or a BS that performs various functions disclosed with reference to FIGS. 1 through 11.

Transceiver 1220 has transmitter 1222 (e.g., transmitting/transmission circuitry) and receiver 1224 (e.g., receiving/reception circuitry) and may be configured to transmit and/or receive time and/or frequency resource partitioning information. Transceiver 1220 may be configured to transmit in different types of subframes and slots including, but not limited to, usable, non-usable, and flexibly usable subframes and slot formats. Transceiver 1220 may be configured to receive data and control channels.

Node 1200 may include a variety of computer-readable media. Computer-readable media may be any available media that may be accessed by node 1200 and include volatile (and/or non-volatile) media and removable (and/or non-removable) media.

The computer-readable media may include computer-storage media and communication media. Computer-storage media may include both volatile (and/or non-volatile media) and removable (and/or non-removable) media implemented in any method or technology for storage of information, such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

Memory 1234 may include computer-storage media in the form of volatile and/or non-volatile memory. Memory 1234 may be removable, non-removable, or a combination thereof. Example memory may include solid-state memory, hard drives, optical-disc drives, etc. As illustrated in FIG. 12, memory 1234 may store a computer-readable and/or computer-executable instruction 1232 (e.g., software codes or program(s)) that are configured to, when executed, cause processor 1228 to perform various functions disclosed herein, for example, with reference to FIGS. 1 through 11. Alternatively, instruction 1232 may not be directly executable by processor 1228 but may be configured to cause node 1200 (e.g., when compiled and executed) to perform various functions disclosed herein.

Processor 1228 (e.g., having processing circuitry) may include an intelligent hardware device, e.g., a Central Processing Unit (CPU), a microcontroller, an ASIC, etc. Processor 1228 may include a memory. Processor 1228 may process data 1230 and instruction 1232 received from memory 1234, and information transmitted and received via transceiver 1220, the baseband communications module, and/or the network communications module. Processor 1228 may also process information to send to transceiver 1220 for transmission via antenna 1236 to the network communications module for transmission to a Core Network (CN).

One or more presentation components 1238 may present data indications to a person or another device. Examples of presentation components 1238 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

1. A method for performing uplink transmissions by a User Equipment (UE), the method comprising:
receiving, from a Base Station (BS), at least one configuration indicating a first threshold;
initiating a Random Access (RA) procedure;
determining whether to perform Multiple Physical Random Access Channel (PRACH) (MP) transmissions based on, at least, a comparison between a measurement result and the first threshold; and
selecting a PRACH resource configured for the MP transmissions in response to determining that the MP transmissions are to be performed,
wherein performing the MP transmissions comprises transmitting, repeatedly, an RA preamble, on the PRACH resource configured for the MP transmissions, before the UE begins monitoring a Physical Downlink Control Channel (PDCCH) for receiving a Random Access Response (RAR) that corresponds to the RA preamble.

2. The method according to claim 1, wherein the measurement result comprises at least one Reference Signal Received Power (RSRP) value of at least one pathloss Reference Signal (RS), the method further comprising:
performing a set of operations after determining that all of the at least one RSRP value is less than the first threshold, performing the set of operations comprising:
determining whether the at least one pathloss RS is associated with at least one MP-specific PRACH resource that is configured for the UE to perform the MP transmissions, the at least one MP-specific PRACH resource comprising the PRACH resource configured for the MP transmissions; and
performing the MP transmissions after determining that the at least one pathloss RS is associated with the at least one MP-specific PRACH resource.

3. The method according to claim 2, wherein performing the set of operations further comprises:
performing a Single-PRACH (SP) transmission after determining that none of the at least one pathloss RS is associated with the at least one MP-specific PRACH resource, performing the SP transmission comprising:
transmitting the RA preamble for the RA procedure only once before the UE begins monitoring the PDCCH for receiving the RAR that corresponds to the RA preamble.

4. The method according to claim 2, wherein selecting the PRACH resource configured for the MP transmissions comprises:
selecting an MP-specific PRACH resource, among the at least one MP-specific PRACH resource, as the PRACH resource for transmitting the RA preamble.

5. The method according to claim 1, further comprising:
performing the MP transmissions after determining that the measurement result is less than the first threshold; and
performing a Single-PRACH (SP) transmission after determining that the measurement result is equal to or greater than the first threshold, performing the SP transmission comprising:
transmitting the RA preamble for the RA procedure only once before the UE begins monitoring the PDCCH for receiving the RAR that corresponds to the RA preamble.

6. The method according to claim 1, wherein selecting the PRACH resource configured for the MP transmissions comprises:
selecting the PRACH resource by comparing the measurement result with the first threshold.

7. The method according to claim 1, wherein selecting the PRACH resource configured for the MP transmissions comprises:
selecting the PRACH resource by comparing the measurement result with a second threshold,
wherein the first threshold and the second threshold are independently indicated by the at least one configuration.

8. The method according to claim 1, further comprising:
receiving, from the BS, an indication of whether a second threshold is used as the first threshold,
wherein the second threshold is configured for the UE to select the PRACH resource for transmitting the RA preamble.

9. The method according to claim 1, further comprising:
determining whether to indicate to the BS that the UE is capable of performing Message 3 (MSG3) repetitions according to the first threshold, performing the MSG3 repetitions comprising:
transmitting repeatedly, an MSG3 for the RA procedure after receiving the RAR.

10. A User Equipment (UE) for performing uplink transmissions, the UE comprising:
at least one processor; and
at least one non-transitory computer-readable medium coupled to the at least one processor and storing one or more computer-executable instructions that, when executed by the at least one processor, cause the UE to:
receive, from a Base Station (BS), at least one configuration indicating a first threshold;
initiate a Random Access (RA) procedure;
determine whether to perform Multiple Physical Random Access Channel (PRACH) (MP) transmissions based on, at least, a comparison between a measurement result and the first threshold; and
select a PRACH resource configured for the MP transmissions in response to determining that the MP transmissions are to be performed,
wherein performing the MP transmissions comprises transmitting, repeatedly, an RA preamble, on the PRACH resource configured for the MP transmissions, before the UE begins monitoring a Physical Downlink Control Channel (PDCCH) for receiving a Random Access Response (RAR) that corresponds to the RA preamble.

11. The UE according to claim 10, wherein the measurement result comprises at least one Reference Signal Received Power (RSRP) value of at least one pathloss Reference Signal (RS), the one or more computer-executable instructions, when executed by the at least one processor, further causing the UE to:
perform a set of operations after the UE determines that all of the at least one RSRP value is less than the first threshold, performing the set of operations comprising:
determining whether the at least one pathloss RS is associated with at least one MP-specific PRACH resource that is configured for the UE to perform the MP transmissions, the at least one MP-specific PRACH resource comprising the PRACH resource configured for the MP transmissions; and
performing the MP transmissions after the UE determines that the at least one pathloss RS is associated with the at least one MP-specific PRACH resource.

12. The UE according to claim 11, wherein performing the set of operations further comprises:
performing a Single-PRACH (SP) transmission after the UE determines that none of the at least one pathloss RS is associated with the at least one MP-specific PRACH resource, performing the SP transmission comprising:
transmitting the RA preamble for the RA procedure only once before the UE begins monitoring the PDCCH for receiving the RAR that corresponds to the RA preamble.

13. The UE according to claim 11, wherein selecting the PRACH resource configured for the MP transmissions comprises:
selecting an MP-specific PRACH resource, among the at least one MP-specific PRACH resource, as the PRACH resource for transmitting the RA preamble.

14. The UE according to claim 10, wherein the one or more computer-executable instructions, when executed by the at least one processor, further cause the UE to:
perform the MP transmissions after the UE determines that the measurement result is less than the first threshold; and
perform a Single-PRACH (SP) transmission after the UE determines that the measurement result is equal to or greater than the first threshold, performing the SP transmission comprising:
transmitting the RA preamble for the RA procedure only once before the UE begins monitoring the PDCCH for receiving the RAR that corresponds to the RA preamble.

15. The UE according to claim 10, wherein selecting the PRACH resource configured for the MP transmissions comprises:
selecting the PRACH resource by comparing the measurement result with the first threshold.

16. The UE according to claim 10, wherein selecting the PRACH resource configured for the MP transmissions comprises:
selecting the PRACH resource by comparing the measurement result with a second threshold,
wherein the first threshold and the second threshold are independently indicated by the at least one configuration.

17. The UE according to claim 10, wherein the one or more computer-executable instructions, when executed by the at least one processor, further cause the UE to:
receive, from the BS, an indication of whether a second threshold is used as the first threshold,
wherein the second threshold is configured for the UE to select the PRACH resource for transmitting the RA preamble.

18. The UE according to claim 10, wherein the one or more computer-executable instructions, when executed by the at least one processor, further cause the UE to:
determine whether to indicate to the BS that the UE is capable of performing multiple Message 3 (MSG3) repetitions according to the first threshold, performing the MSG3 repetitions comprising:
transmitting, repeatedly, an MSG3 for the RA procedure after the UE receives the RAR.

19. A Base Station (BS) for communicating with a User Equipment (UE) performing uplink transmissions, the BS comprising:
at least one processor; and
at least one non-transitory computer-readable medium coupled to the at least one processor and storing one or more computer-executable instructions that, when executed by the at least one processor, cause the BS to:
transmit at least one configuration indicating a first threshold to the UE;
transmit at least one pathloss Reference Signal (RS) to the UE, causing the UE to determine whether to perform Multiple Physical Random Access Channel (PRACH) (MP) transmissions based on, at least, a comparison between a measurement result and the first threshold, and further causing the UE to select a PRACH resource configured for the MP transmissions in response to determining that the MP transmissions are to be performed; and
receive, repeatedly, a Random Access (RA) preamble for an RA procedure in response to the UE performing the MP transmissions.

20. The BS according to claim 19, wherein the one or more computer-executable instructions, when executed by the at least one processor, further cause the BS to:
transmit an indication of whether a second threshold is used as the first threshold to the UE,
wherein the second threshold is configured for the UE to select the PRACH resource for transmitting the RA preamble.
